(19) United States
(12) Patent Application Publication
(10) Pub. No.: US 2025/0377611 A1
(43) Pub. Date: Dec. 11, 2025

(54) EXPOSURE APPARATUS AND IMAGE FORMING APPARATUS

(71) Applicant: CANON KABUSHIKI KAISHA, Tokyo (JP)

(72) Inventors: MASANORI SHIBATA, Tokyo (JP); MIZUKI NAGASAKI, Kanagawa (JP)

(21) Appl. No.: 19/227,770

(22) Filed: Jun. 4, 2025

(30) Foreign Application Priority Data
Jun. 10, 2024 (JP) 2024-093863

(51) Int. Cl. G03G 15/043; B41J 2/447; B41J 2/47; G03G 15/04

(52) U.S. Cl. CPC G03G 15/043; B41J 2/447; B41J 2/47; G03G 15/04036

(57) ABSTRACT

An exposure apparatus including a light-emitting chip including light-emitting elements and a controller is provided. The light-emitting elements are divided into blocks. The controller controls the light-emitting elements so as to form an electrostatic latent image that is constituted by spots and each of the spots is formed by a predetermined number of light-emitting elements, and changes the number of light-emitting elements that form a spot from the predetermined number in accordance with correction data for correcting a width of the image in the axial direction, and shifts, in accordance with a change in the number of light-emitting elements that form the spot, positions of some of other spots. The spot is formed by using a light-emitting element excluding light-emitting elements provided on columns at two ends of each block.

### BACKGROUND

### Field of the Technology

The present disclosure relates to an exposure apparatus and an image forming apparatus.

### Description of the Related Art

An image forming apparatus based on an electrophotographic system forms an image by forming an electrostatic latent image on a photoconductive body that is rotated/driven, upon exposing the photoconductive body, and developing the formed electrostatic latent image with a toner. Japanese Patent Laid-Open No. 2024-031853 discloses an image forming apparatus including an exposure apparatus using organic electroluminescence (EL) elements. In addition, Japanese Patent Laid-Open No. 2024-031853 discloses a technique of compensating for the positional shift of an image due to variation in the mounting position of a light-emitting chip on the substrate of the exposure head of the exposure apparatus, the thermal expansion of the substrate, and the like. Japanese Patent Laid-Open No. 2022-162410 discloses a light-emitting chip including a plurality of groups each constituted by a plurality of light-emitting elements and a drive circuit that drives the light-emitting elements.

### SUMMARY

In the light-emitting chip including the groups disclosed in Japanese Patent Laid-Open No. 2022-162410, when data is inserted or thinned-out to compensate for a magnification error, there is a possibility that unevenness due to compensation for a magnification error will be visually recognized depending on the insertion or thinning-out position of data.

Some embodiments of the present disclosure provide a technique advantageous in suppressing a deterioration in image quality.

According to some embodiments, an exposure apparatus comprising: a light-emitting chip including a plurality of light-emitting elements that constitute a plurality of rows and a plurality of columns and are arranged such that a row direction extends along an axial direction of a photoconductive body; and a light emission controller configured to control the light-emitting chip, wherein a light emission region in which the plurality of light-emitting elements are arranged is divided into a plurality of blocks arranged along the row direction, and each light-emitting element is driven by a drive circuit provided in correspondence with a block to which the light-emitting element belongs, the light emission controller is configured to control the plurality of light-emitting elements so as to form, on the photoconductive body, an electrostatic latent image that is for forming an image and is constituted by a plurality of spots, during rotation of the photoconductive body, and each of the plurality of spots is formed by a predetermined number of light-emitting elements among the plurality of light-emitting elements, the light emission controller is configured to change the number of light-emitting elements that form at least one spot among the plurality of spots from the predetermined number in accordance with correction data for correcting a width of the image in the axial direction, and shifts, in accordance with a change in the number of light-emitting elements that form the at least one spot, positions of some of other spots, and the at least one spot is formed by using a light-emitting element among the plurality of light-emitting elements excluding light-emitting elements provided on columns at two ends of each block in the row direction, is provided.

According to some other embodiments, an exposure apparatus comprising: a light-emitting chip including a plurality of light-emitting elements that constitute a plurality of rows and a plurality of columns and are arranged such that a row direction extends along an axial direction of a photoconductive body; and a light emission controller configured to control the light-emitting chip, wherein a light emission region in which the plurality of light-emitting elements are arranged is divided into a plurality of blocks arranged along the row direction, and each light-emitting element is driven by a drive circuit provided in correspondence with a block to which the light-emitting element belongs, the light emission controller is configured to control the plurality of light-emitting elements based on an image formation data string for forming an image, the light emission controller is configured to perform insertion or thinning-out processing of at least one data of the data string corresponding to at least one row of the plurality of light-emitting elements in accordance with correction data for correcting a width of the image in the axial direction, and the processing is performed for data corresponding to a light-emitting element among the plurality of light-emitting elements excluding light-emitting elements arranged on columns at two ends of each block in the row direction, is provided.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing an example of the arrangement of an image forming apparatus using an exposure apparatus according to the present embodiment;

FIGS. 2A and 2B are views showing examples of the arrangements of a photoconductive body and an exposure head according to the present embodiment;

FIG. 3 is a view showing an example of the arrangement of the printed circuit board of an exposure head according to the present embodiment;

FIG. 4 is a view showing an example of the arrangement of a light-emitting chip according to the present embodiment;

FIG. 5 is a circuit diagram showing an example of an arrangement for controlling the light-emitting chip according to the present embodiment;

FIG. 6 is a block diagram showing an example of the arrangement of the light-emitting chip according to the present embodiment;

FIG. 7 is a circuit diagram showing an example of the arrangement of the drive circuit of the light-emitting chip according to the present embodiment;

FIG. 8 is a view for explaining multiple exposure using the light-emitting chip according to the present embodiment;

FIGS. 9A to 9D are views for explaining light emission control based on image data from the exposure apparatus according to the present embodiment;

FIGS. 10A to 10D are views for explaining compensation (data insertion) for a magnification error in the exposure apparatus according to the present embodiment;

FIGS. 11A to 11D are views for explaining compensation (data thinning-out) for a magnification error in the exposure apparatus according to the present embodiment;

FIGS. 12A and 12B are views for explaining compensation for a magnification error in the exposure apparatus according to the present embodiment;

FIG. 13 is a layout diagram showing an example of the arrangement of a light-emitting device according to the present embodiment; and

FIGS. 14A to 14C are layout diagrams showing an example of an exposure head using the light-emitting device according to the present embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

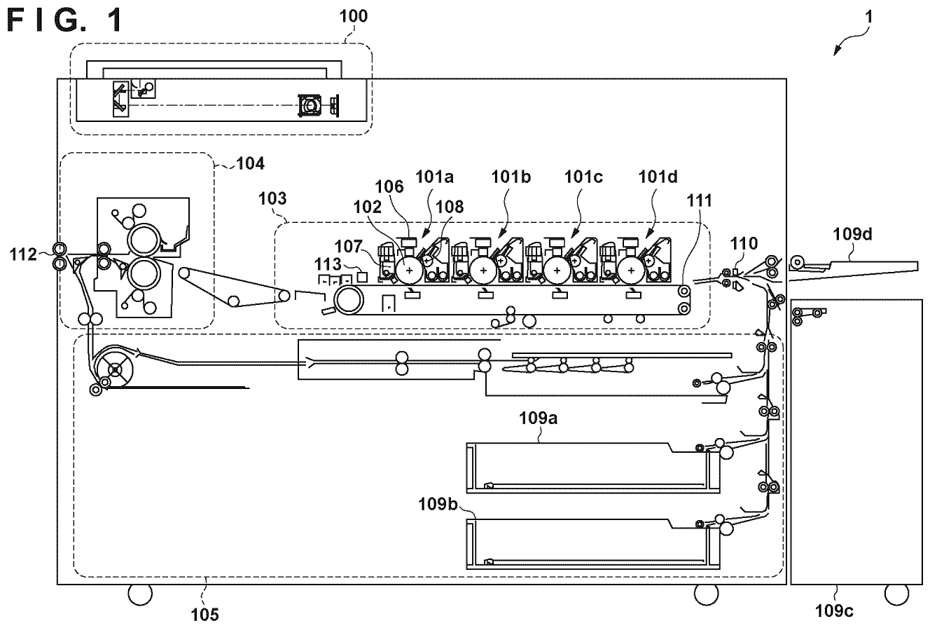

An exposure apparatus according to an embodiment of the present disclosure will be described with reference to FIG. 1 to FIGS. 14A to 14C. FIG. 1 is a view showing the schematic arrangement of an image forming apparatus 1 including the exposure apparatus according to the present embodiment. The image forming apparatus 1 includes a reading unit 100, an image forming unit 103, a fixing unit 104, and a conveying unit 105. The reading unit 100 optically reads a document placed on a document table and generates read image data. The image forming unit 103 forms an image on a sheet based on the read image data generated by the reading unit 100 or the printing image data received from an external apparatus via a network. The image forming unit 103 includes image forming units 101a to 101d. The image forming units 101a to 101d can respectively form black, yellow, magenta, and cyan toner images. The image forming units 101a to 101d can have the same arrangement. For this reason, the image forming units 101a to 101d are each sometimes simply referred to as an image forming unit 101 hereinafter unless specified as a specific image forming unit. At the time of forming an image, a photoconductive body 102 of the image forming unit 101 is rotated/driven in the clockwise direction in FIG. 1. A charger 107 charges the photoconductive body 102. An exposure head 106 exposes the photoconductive body 102 to light to form an electrostatic latent image on the surface of the photoconductive body 102. A developing unit 108 forms a toner image by developing the electrostatic latent image on the photoconductive body 102 with a toner. The toner image formed on the surface of the photoconductive body 102 is transferred onto a sheet conveyed on a transfer belt 111. Superimposing and transferring the toner images formed on the four photoconductive bodies 102 onto the sheet can form a color image including four color components of black, yellow, magenta, and cyan. The conveying unit 105 controls the feeding and conveyance of sheets. More specifically, the conveying unit 105 feeds a sheet from a designated unit among internal storage units 109a and 109b, an external storage unit 109c, and a manual feed unit 109d to a conveyance path of the image forming apparatus 1. The fed sheet is conveyed up to a registration roller 110. The registration roller 110 conveys the sheet onto the transfer belt 111 at a proper timing so as to transfer the toner images formed on the respective photoconductive bodies 102 onto the sheet. While the sheet is conveyed on the transfer belt 111 in the above manner, the toner images are transferred onto the sheet. The fixing unit 104 fixes the toner images on the sheet by heating and pressurizing the sheet onto which the toner images are transferred. After the toner images are fixed, discharge rollers 112 discharge the sheet to the outside of the image forming apparatus 1. An optical sensor 113 is provided at a position facing the transfer belt 111. The optical sensor 113 optically reads the test chart formed on the transfer belt 111 by the image forming unit 101. If an error is detected concerning an image formation range from the test chart read by the optical sensor 113, an image controller 500 described later performs control for compensating for the error at the execution of a job afterward. The above description has exemplified the case where a toner image is directly transferred from each photoconductive body 102 onto a sheet on the transfer belt 111. However, limitation is not made thereto, and a toner image may be indirectly transferred from each photoconductive body 102 onto a sheet via an intermediate transfer body. Although the above description has exemplified the case where a color image is formed by using toners of a plurality of colors, the technique according to the present disclosure can also be applied to an image forming apparatus that forms a monochrome image by using a single color toner.

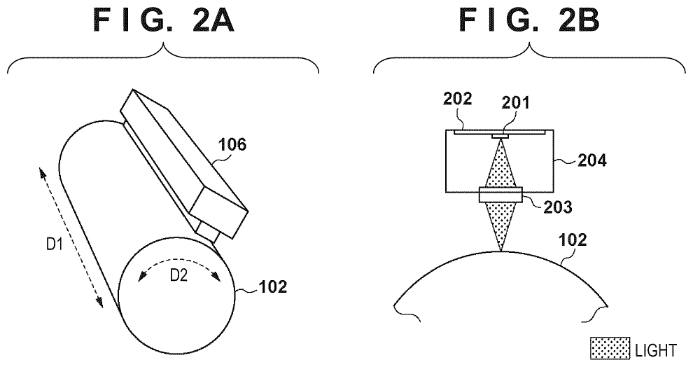

FIGS. 2A and 2B are views for explaining the arrangement of the exposure head according to the present embodiment. The exposure head 106 can include a light-emitting element array 201, a printed circuit board 202 on which the light-emitting element array 201 is mounted, a rod lens array 203, and a housing 204 that supports the printed circuit board 202 and the rod lens array 203. The photoconductive body 102 has a cylindrical shape. The exposure head 106 is placed such that its longitudinal direction is parallel to an axial direction D1 of the photoconductive body 102, and the surface on which the rod lens array 203 is mounted faces the surface of the photoconductive body 102. While the photoconductive body 102 rotates in a circumferential direction D2, the light-emitting element array 201 of the exposure head 106 emits light, and the rod lens array 203 focuses the light on the surface of the photoconductive body 102.

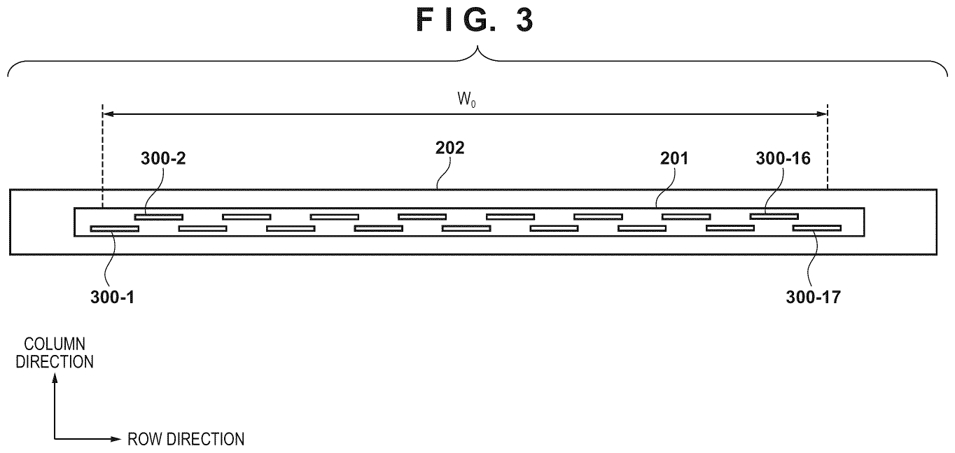

FIG. 3 is a view for explaining the arrangement of the printed circuit board of the exposure head according to the present embodiment. In the present embodiment, the light-emitting element array 201 is constituted by 17 light-emitting chips 300-1 to 300-17. The light-emitting chips 300-1 to 300-17 are arranged in a staggered pattern along the axial direction D1 of the photoconductive body 102. The light-emitting chips 300-1 to 300-17 each are sometimes simply referred to as a light-emitting chip 300 hereinafter unless specified as a specific light-emitting chip. The range occupied by all the 17 light-emitting chips 300 in the axial direction D1 of the photoconductive body 102 may be wider than the range occupied by a maximum width W₀ of input image data. Accordingly, some light-emitting elements located at both ends of the photoconductive body 102 along the axial direction D1 need not be used for exposing the photoconductive body 102 to light unless no error in the image formation range is detected. In the following, for the sake of descriptive convenience, the side with smaller suffix numbers and the side with larger suffix numbers of the light-emitting chips 300-1 to 300-17, which are arranged along the axial direction D1, are called “left” and “right”, respectively. For example, the light-emitting chip 300-1 is the light-emitting chip 300 at the “left end”, and the light-emitting chip 300-17 is the light-emitting chip at the “right end”.

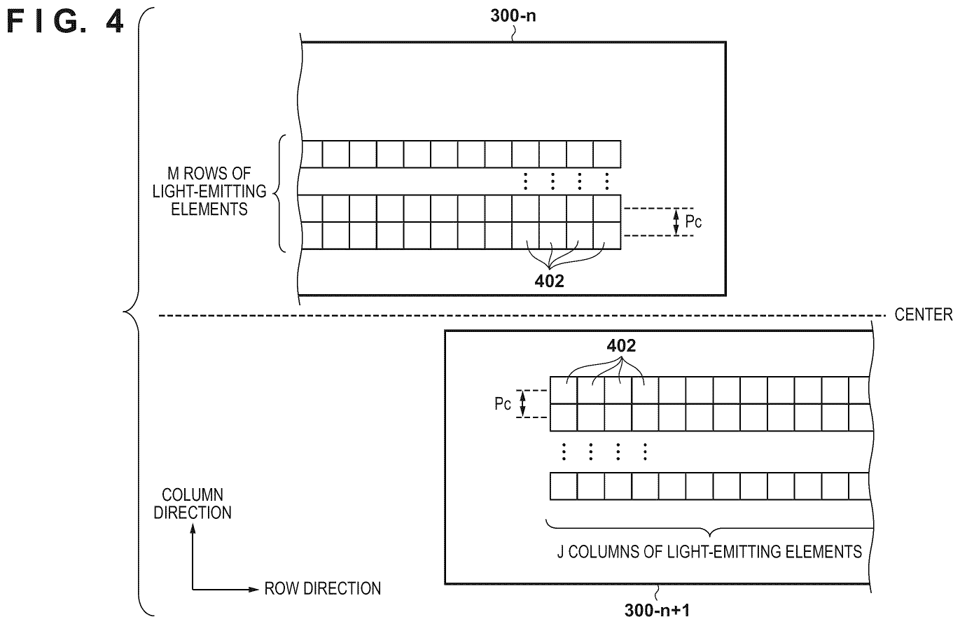

FIG. 4 is a view for explaining a light-emitting chip and the array of the light-emitting elements in the light-emitting chip according to the present embodiment. FIG. 4 schematically shows the light-emitting chip 300 and the array of light-emitting elements 402 arranged in the light-emitting chip 300. In the present embodiment, the light-emitting element array 201 includes a plurality of light-emitting elements 402 two-dimensionally arrayed so as to form a plurality of rows and a plurality of columns. The light-emitting element array 201 includes, as a whole, N columns of the light-emitting elements 402 in the row direction along the axial direction D1 of the photoconductive body 102 and M rows of the light-emitting elements 402 in the column direction along the circumferential direction D2 of the photoconductive body 102. In this case, M and N are integers equal to or more than 2. In each light-emitting chip 300, the light-emitting elements 402 are arrayed so as to form a plurality of rows and a plurality of columns. A count J (J=N/17) of the light-emitting elements 402 arrayed on each row of one light-emitting chip 300 may be, for example, 872 (J=872). On the other hand, a count M of the light-emitting elements 402 arrayed on each column of one light-emitting chip 300 may be, for example, 4 (M=4). That is, in an exemplary embodiment, each light-emitting chip 300 includes a total of 3,488 (=872×4) light-emitting elements 402, with 872 light-emitting elements 402 arrayed in the row direction along the axial direction D1 of the photoconductive body 102, and 4 light-emitting elements 402 arrayed in the column direction along the circumferential direction D2 of the photoconductive body 102. An interval P_{c} between the central points of the light-emitting elements 402 adjacent to each other in the column direction may be, for example, about 21.16 μm corresponding to a resolution of 1,200 dpi. The interval between the central points of the light-emitting elements 402 adjacent to each other in the row direction may also be about 21.16 μm. In this case, the 872 light-emitting elements 402 occupy a length of about 18.5 mm in the row direction. For the sake of descriptive convenience, FIG. 4 shows an example in which the light-emitting elements 402 are completely arrayed in a lattice pattern in each light-emitting chip 300. In practice, however, the M (M=4) light-emitting elements 402 on each column are partially shifted at a predetermined pitch stepwise in the row direction. This point will be further described later.

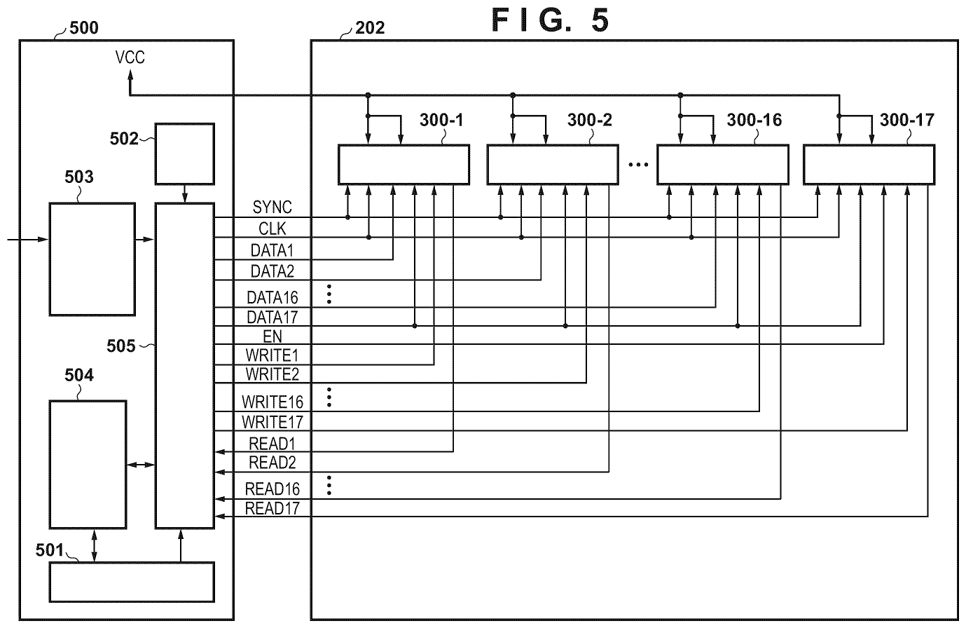

FIG. 5 is a block diagram concerning an arrangement for controlling the light-emitting chip 300. The image controller 500 is a control circuit that communicates with the printed circuit board 202 via a plurality of signal lines. The image controller 500 can include a CPU 501, a clock generator 502, an image data processor 503, a register access unit 504, and a light emission controller 505. The light emission controller 505 is a constituent element constituting the exposure apparatus together with the exposure head 106 of the light-emitting chip 300. The light emission controller 505 can be regarded as a control circuit for controlling the light-emitting chip 300.

The nth light-emitting chip 300-n (in the present embodiment, n is an integer from 1 to 17) on the printed circuit board 202 is connected to the light emission controller 505 via a signal line DATAn and a signal line WRITEn. The signal line DATAn is used to transmit image data from the image controller 500 to the light-emitting chip 300-n. The signal line WRITEn is used to make the image controller 500 write control data in the register of the light-emitting chip 300-n. The CPU 501 controls the overall image forming apparatus 1. The image data processor 503 performs image processing for image data received from the reading unit 100 or an external apparatus to generate image data in a binary bitmap format for controlling light or non-light emission of the light-emitting element 402 of the light-emitting chip 300 on the printed circuit board 202. The image data processor 503 transmits the generated image data as input image data to the light emission controller 505. The register access unit 504 receives control data to be written in the register in each light-emitting chip 300 from the CPU 501 and transmits the data to the light emission controller 505.

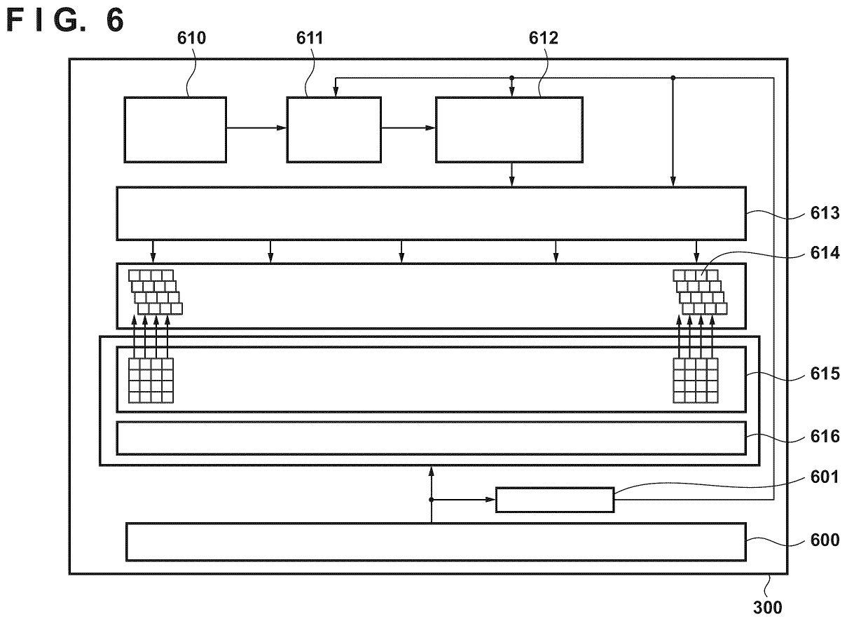

The arrangement of the light-emitting chip 300 will be described next. FIG. 6 is a circuit block diagram of the light-emitting chip 300 according to the present embodiment. The light-emitting chip 300 can include an interface circuit 600, a register 601, a reference current generation circuit 610, a programmable current source 611, a bias current source 612, a current control circuit 613, a drive transistor 614, a data holding circuit 615, and a shift register 616. The interface circuit 600 receives mode information and information concerning image data from the light emission controller 505 and outputs a data signal to the register 601 and the shift register 616. The programmable current source 611 outputs an analog current corresponding to a digital value supplied from the register 601 with reference to an output current from the reference current generation circuit 610 to the bias current source 612. The drive current of the drive transistor 614 is controlled in accordance with the set value of the register 601. The bias current source 612 supplies an output current corresponding to the set value set in the register 601 to the current control circuit 613. The current control circuit 613 generates a bias voltage for the drive transistor 614. The shift register 616 controls the timing of light emission or non-light emission of the light-emitting element 402 based on a data signal from the interface circuit 600. The data holding circuit 615 holds information corresponding to each light-emitting element 402 and determines light emission or non-light emission of the light-emitting element 402. The drive transistor 614 is connected to the light-emitting element 402. A drive current for the drive transistor 614 is determined by the bias voltage supplied from the current control circuit 613. The drive transistor 614 controls light emission or non-light emission of the light-emitting element in accordance with the signal supplied from the data holding circuit 615.

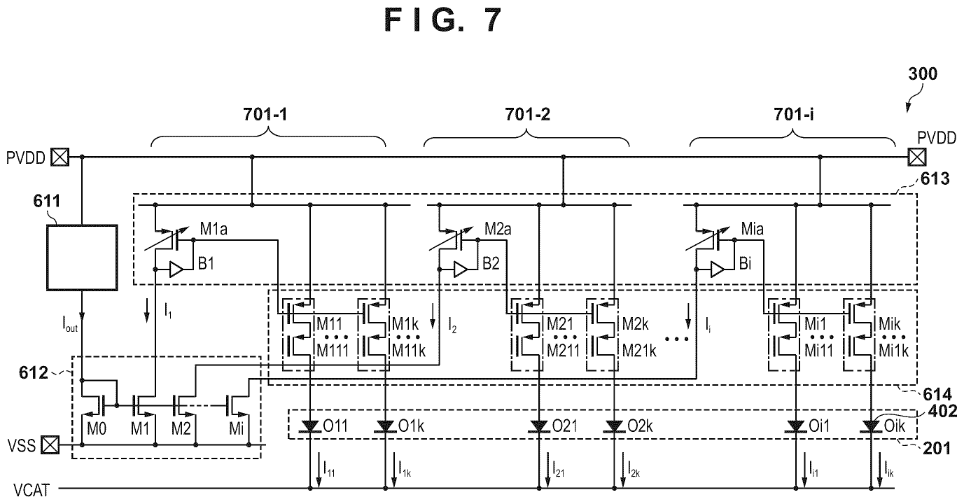

FIG. 7 is a circuit diagram focusing on the drive transistor 614 of the light-emitting chip 300 according to the present embodiment. The adjustment and light emission control of the light-emitting element 402 will be described. The bias current source 612 is constituted by transistors M0 to Mi. The current control circuit 613 is constituted by transistors M1a to Mia and buffers B1 to Bi connected between the gate terminals and the drain terminals of the transistors M1a to Mia. The drive transistor 614 is constituted by first transistors M11 to Mik and second transistors M111 to Milk. The transistors M111 to Milk are respectively connected to light-emitting elements O11 to Oik in series. In this case, the light-emitting elements O11 to Oik correspond to the light-emitting elements 402 described above.

In the present embodiment, the light emission region in which the plurality of light-emitting elements 402 of the light-emitting chip 300 are arranged is divided into a plurality of blocks 701 arrayed along the row direction, and each light-emitting element 402 is driven by a drive circuit provided to correspond to the block 701 to which the light-emitting element 402 belongs. Focus on a block 701-1 among the blocks 701. The block 701-1 includes the transistor M1a of the current control circuit 613, the first transistors M11 to M1k and the second transistors M111 to M11k of the drive transistor 614, and the light-emitting elements O11 to O1k. The light-emitting elements O11 to O1k (the light-emitting elements 402) can be regarded to be driven by a drive circuit including the transistor M1a of the current control circuit 613, and the first transistors M11 to M1k and the second transistors M111 to M11k of the drive transistor 614. Likewise, the block 701-i includes the transistor Mia of the current control circuit 613, the first transistors Mi1 to Mik and the second transistors ill to Milk of the drive transistor 614, and the light-emitting elements Oi1 to Oik. The light-emitting elements Oi1 to Oik (the light-emitting elements 402) are driven by a drive circuit including the transistor Mia of the current control circuit 613, and the first transistors Mi1 to Mik and the second transistors Mi11 to Mi1k of the drive transistor 614.

An output current Iout of the programmable current source 611 is connected to the drain terminal of the transistor M0 of the bias current source 612. The transistor M0 is diode-connected, and the bias voltage determined by output current Iₒᵤₜ is commonly applied to the gates of the transistors M0 to Mi.

In the block 701, for example, the block 701-1, the drain terminal of the transistor M1a and the drain terminal of the transistor M1, which constitute the current control circuit 613, are connected in series. The gate terminal of the transistor M1a is connected to the drain terminal of the transistor M1a via the buffer B1. The voltage determined by a current I₁ is commonly applied to the gates of the first transistors M11 to M1k. The voltages between the gates and the sources of the first transistors M11 to M1k are the same, and hence equal drive currents can be supplied to the light-emitting elements O11 to O1k. Although not explicitly shown in FIG. 7, drive voltages are applied from the data holding circuit 615 to the gates of the second transistors M111 to M11k. This controls whether to supply drive currents to the light-emitting elements O1 to O1k. That is, the second transistors M111 to M11k function as switches. The light-emitting elements O11 to O1k are driven by the first transistors M11 to M1k and the second transistors M111 to M11k to emit light.

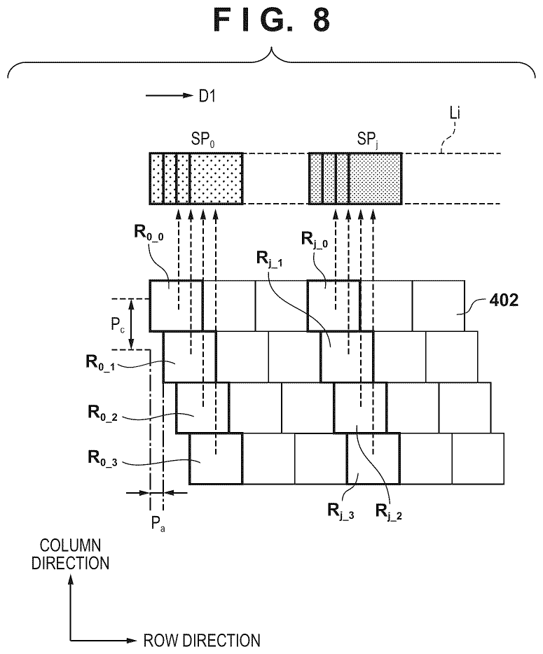

FIG. 4 described above shows the example in which the light-emitting elements 402 are perfectly arranged in the matrix pattern in each light-emitting chip 300. However, in the present embodiment, the M light-emitting elements 402 on each column are arranged so as to be partially shifted in the row direction stepwise at a predetermined pitch. For example, the light-emitting elements 402, of the plurality of light-emitting elements 402, which are arranged on each column may be arranged such that at least one light-emitting element 402 is partially shifted in the row direction. FIG. 8 is a view for explaining multiple exposure performed by the light-emitting elements 402 arranged stepwise in the present embodiment.

FIG. 8 partially shows an example of the layout of the light-emitting elements 402 in the light-emitting chip 300 when M=4. Referring to FIG. 8, R_{j_m} (j={0, 1, . . . , J−1}(J=872), m={0, 1, 2, 3}) indicates the light-emitting element 402 at the jth column from the left in the row direction of the light-emitting chip 300 along the axial direction D1 of the photoconductive body 102 and the mth row from above in the column direction intersecting the row direction. In the following description, the specific light-emitting element 402, of the light-emitting elements 402, which is placed at the jth column and the mth row is sometimes referred to as a “light-emitting element R_{j_m}”.

As described above, a pitch P_{c} of the light-emitting elements 402 in the column direction may be about 21.16 μm. The shift interval between the two adjacent light-emitting elements 402 of the M light-emitting elements 402 on each column in the row direction, that is, a pitch Pₐ between the light-emitting elements 402 in the row direction may be about 5 μm which corresponds to a resolution of 4,800 dpi. Arraying the four light-emitting elements 402 on each column stepwise in this manner makes every two adjacent light-emitting elements 402 of the four light-emitting elements 402 occupy ranges partially overlap each other in the row direction. The four light-emitting elements 402 on a column corresponding to each pixel position of image data sequentially emit light during the rotation of the photoconductive body 102 to form a spot SP corresponding to each pixel position on the surface of the photoconductive body 102. In this case, the spot SP corresponding to each pixel position corresponds to a pixel of an image formed on a sheet. The light emission controller 505 controls the plurality of light-emitting elements 402 so as to form, on the photoconductive body 102, an electrostatic latent image for forming an image, which is constituted by the plurality of spots SP during the rotation of the photoconductive body 102. In addition, each of the plurality of spots SP can be regarded to be formed by a predetermined number (for example, four) of light-emitting elements 402 of the plurality of light-emitting elements 402.

In the example shown in FIG. 8, when the data of the pixel value at the left end of the ith row of the image data indicates ON of light emission, light-emitting elements R_{0_0}, R_{0_1}, R_{0_2}, and R_{0_3} sequentially emit light at timings each facing a line Li on the surface of the photoconductive body 102. As a result, a spot region at the left end of the line Li is subjected to multiple exposure, thereby forming a corresponding spot SP₀. Likewise, when the data of the jth pixel value on the ith row of the input image data from the left indicates ON of light emission, light-emitting elements R_{j_0}, R_{j_1}, R_{j_2}, and R_{j_3} sequentially emit light at timings each facing the line Li on the surface of the photoconductive body 102. As a result, the jth spot region on the line Li from the left is subjected to multiple exposure, thereby forming a corresponding spot SPj. In addition, the technique according to the present disclosure is not limited to the case where the M light-emitting elements are arranged stepwise such that every two adjacent light-emitting elements 402 partially overlap each other in the row direction. For example, one light-emitting element of the M light-emitting elements on each column may be placed so as to be shifted in the row direction.

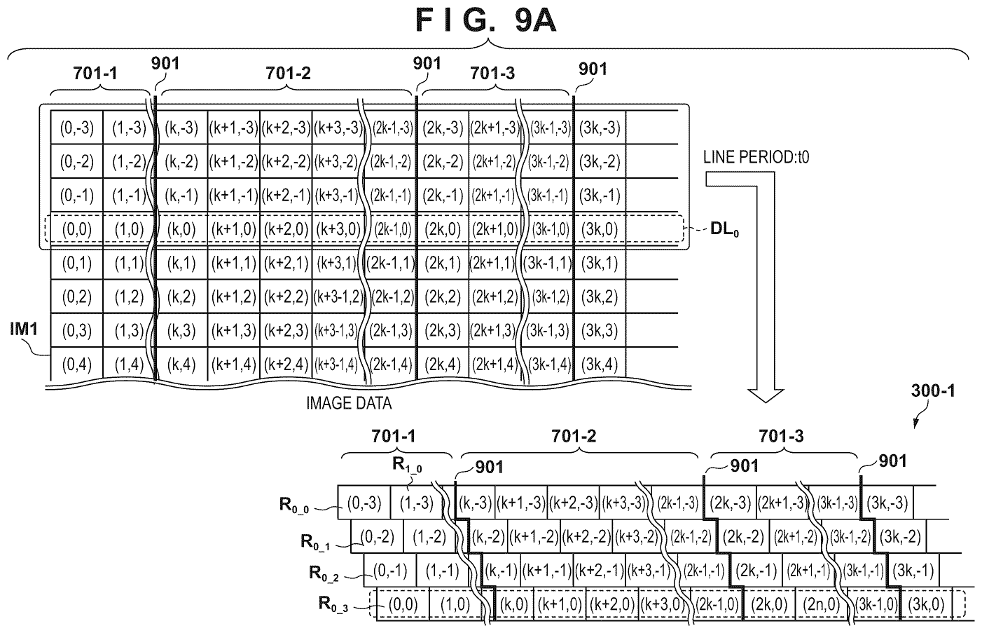

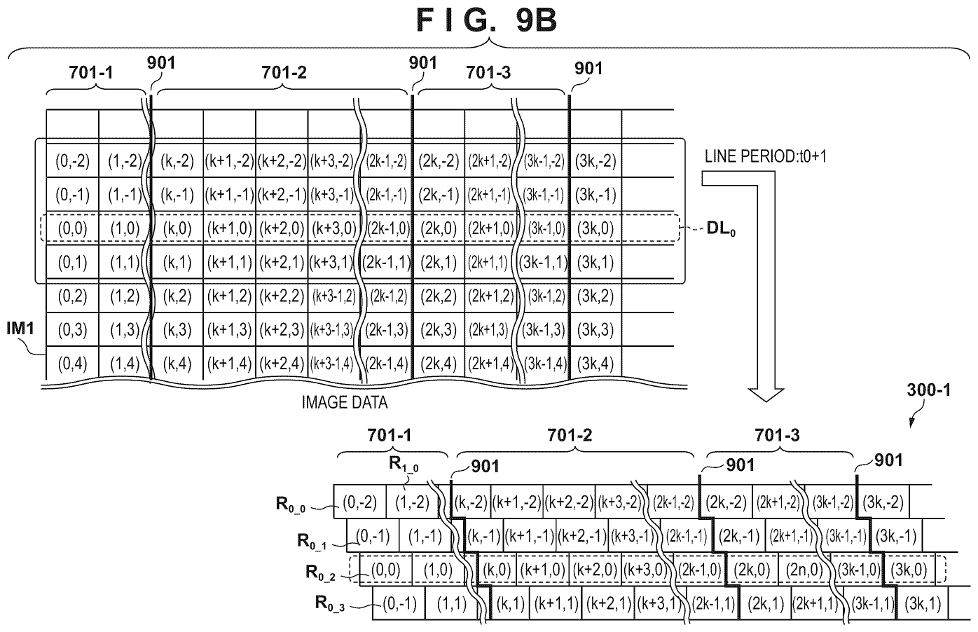

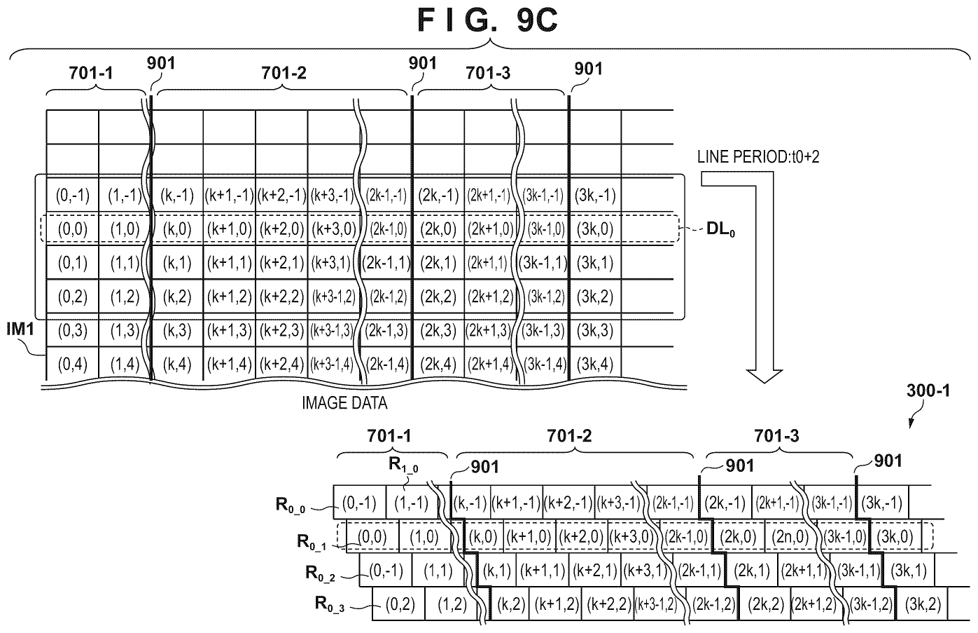

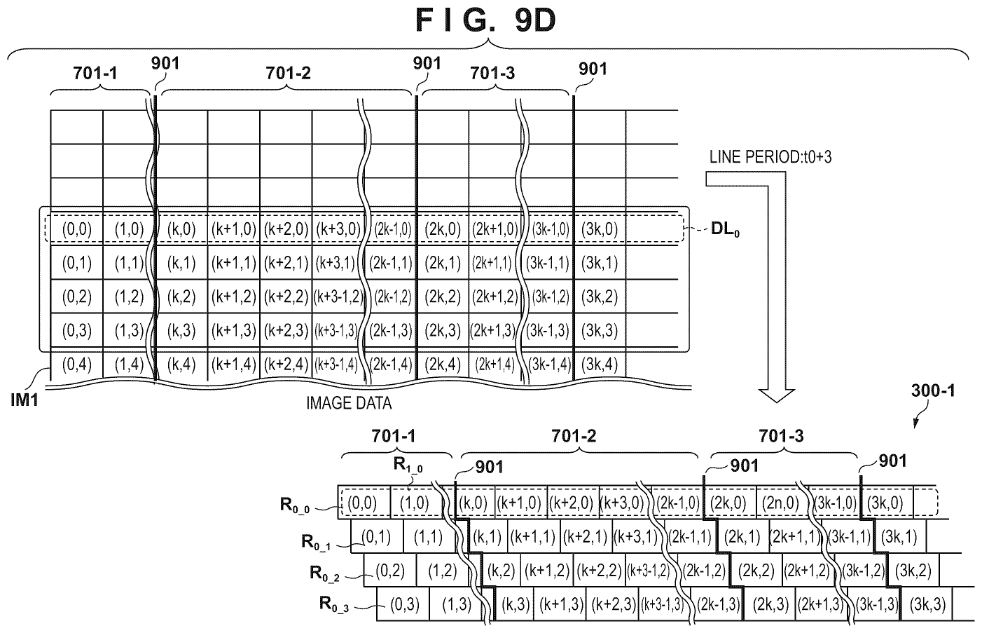

A procedure for light emission control based on image formation data will be described next. FIGS. 9A to 9D are views for explaining the procedure for light emission control based on image formation data (to be sometimes referred to as image data hereinafter). In forming an image, the light emission controller 505 receives image data IM1 in a binary bitmap format from the image data processor 503. On the left side of FIG. 9A, the jth pixel value from the left of the ith row from on the image data IM1, which is a two-dimensional pixel value array, is written as (j, i) (j={0, 1, 2, . . . }, i={0, 1, 2, . . . }). The light emission controller 505 adds dummy data (a pixel value) corresponding to (M−1) rows to the beginning of the image data IM1. In the case of M=4, when the dummy pixel value to be added is included, the range of an index i of the pixel value becomes {−3, −2, −1, 0, 1, 2, . . . } For example, a dummy pixel value may be a value indicating OFF of light emission (for example, zero). The light emission controller 505 can add dummy pixel values to the right and left of the image data IM1 so as to equalize the number of pixel values on one line with the number of light-emitting elements 402 in the row direction. As described above, this is because the range occupied by all the light-emitting elements 402 of the 17 light-emitting chips 300 in the axial direction D1 of the photoconductive body 102 is wider than the range occupied by the maximum width W₀ of the image data IM1 (number of light-emitting elements corresponding to W₀<N (=17×J)). However, for the sake of descriptive convenience, the accompanying drawings and the following description indicate only effective pixel values.

FIGS. 9A to 11D below also show the blocks 701 described with reference to FIG. 7 with respect to the row direction in which the light-emitting elements 402 are arranged. Referring to FIG. 9A, the light-emitting elements 402 arranged on the column corresponding to j=0 to k−1 belong to the block 701-1. Likewise, the light-emitting elements 402 arranged on the column corresponding to j=k to 2k−1 belong to the block 701-2, and the light-emitting elements 402 arranged on the column corresponding to j=2k to 3k−1 belong to the block 701-3. Assume that the boundaries between the respective blocks 701 are block boundaries 901.

In a first line period t0 in image formation (electrostatic latent image formation), the light emission controller 505 reads out the data of 4-line pixel values from on the image data IM1 and outputs the data in increments of 3,488 (=872×4) pixel values of the read pixel values to the light-emitting chip 300 via the signal line DATAn. In focusing on the light-emitting chip 300-1 shown on the right side of FIG. 9A, image data in a readout range RD including the data of the pixel values from (0, −3) to (872, 0) is input via a signal line DATA1 during the line period to. The light-emitting chip 300-1 serial-parallel converts the input image data and respectively supplies the drive signals based on the data of these pixel values to the 3,488 light-emitting elements 402. For example, the drive signals based on pixel values (0, −3), (0, −2), (0, −1), (0, 0), and (1, −3) are respectively supplied to the light-emitting elements R_{0_0}, R_{0_1}, R_{0_2}, R_{0_3}, and R_{1_0}. The drive signals based on the data of the effective pixel values on a line DL0 corresponding to index i=0 of the image data IM1 are respectively supplied to the light-emitting elements on the fourth row including the light-emitting element R_{0_3} surrounded with the broken line in FIG. 9A. As a result, a line L0 on the surface of the photoconductive body 102 is exposed to light in accordance with a pixel value set (data string) on the line DL0 of the image data IM1. At this point of time, however, multiple exposure is on the way, and the formation of the line L0 of an electrostatic latent image is not completed.

FIG. 9B shows the driving of the light-emitting chip 300-1 during a line period t0+1 next to the line period t0. In the line period t0+1, the light emission controller 505 reads out the data of pixel values from (0, −2) to (872, 1) by moving the readout range RD of the image data IM1 downward by one line and outputs the data to the light-emitting chip 300-1 via the signal line DATA1. The light-emitting chip 300-1 supplies the drive signals based on the data of the input pixel values to 3,488 light-emitting elements. For example, the drive signals based on pixel values (0, −2), (0, −1), (0, 0), (0, 1), and (1, −2) are supplied to the light-emitting elements R_{0_0}, R_{0_1}, R_{0_2}, R_{0_3}, and R_{1_0}. In the line period t0+1, the drive signals based on the data of effective pixel values on the line DL0 of the image data IM1 are supplied to the light-emitting elements on the third row including the light-emitting element R_{0_2}. At this time, since the photoconductive body 102 rotates in the circumferential direction D2, the line L0 on the surface of the photoconductive body 102 faces the light-emitting elements on the third row of the light-emitting chip 300-1. As a result, the line L0 on the surface of the photoconductive body 102 is exposed to light again in accordance with the data string on the line DL0 of the image data IM1.

FIG. 9C shows the driving of the light-emitting chip 300-1 during a line period t0+2 next to the line period t0+1. In the line period t0+2, the light emission controller 505 reads out the data of pixel values from (0, −1) to (871, 2) by moving the readout range RD of the image data IM1 downward by one line and outputs the data to the light-emitting chip 300-1 via the signal line DATA1. The light-emitting chip 300-1 supplies the drive signals based on the data of the input pixel values to 3,488 light-emitting elements. In the line period t0+2, the drive signals based on the data of effective pixel values on the line DL0 of the image data IM are supplied to the light-emitting elements on the second row including the light-emitting element R_{0_1}. At this time, the line L0 on the surface of the photoconductive body 102 faces the light-emitting elements on the second row of the light-emitting chip 300-1. As a result, the line L0 on the surface of the photoconductive body 102 is exposed to light for the third time in accordance with the data string on the line DL0 of the image data IM1.

FIG. 9D shows the driving of the light-emitting chip 300-1 during a line period t0+3 next to the line period t0+2. In the line period t0+3, the light emission controller 505 reads out the data of pixel values from (0, 0) to (872, 3) by moving the readout range RD of the image data IM1 downward by one line and outputs the data to the light-emitting chip 300-1 via the signal line DATA1. The light-emitting chip 300-1 supplies the drive signals based on the data of the input pixel values to 3,488 light-emitting elements. In the line period t0+3, the drive signals based on the data of effective pixel values on the line DL0 of the image data IM are supplied to the light-emitting elements on the first row including the light-emitting element R_{0_0}. At this time, the line L0 on the surface of the photoconductive body 102 faces the light-emitting elements on the first row of the light-emitting chip 300-1. As a result, the line L0 on the surface of the photoconductive body 102 is exposed to light for the fourth time in accordance with the data string on the line DL0 of the image data IM1. At this point of time, multiple exposure has been performed by the four light-emitting elements on each column of the light-emitting chip 300, and the formation of the line L0 of an electrostatic latent image is completed. Lines succeeding the line L0 of the electrostatic latent image are formed on the surface of the photoconductive body 102 in the same manner through the repetition of such line periods.

As described above, in the present embodiment, the drive signal based on the pixel value at each pixel position is input to the four light-emitting elements on a corresponding column of the light-emitting element array. More specifically, for example, the drive signal based on the pixel value (0, 0) is input to the four light-emitting elements R_{0_3}, R_{0_2}, R_{0_1}, and R_{0_0}. When the four light-emitting elements R_{0_3}, R_{0_2}, R_{0_1}, and R_{0_0} emit light in accordance with the drive signal, a spot corresponding to the pixel value (0, 0) is formed on the surface of the photoconductive body 102. Likewise, the drive signal based on the pixel value (1, 0) is input to the four light-emitting elements R_{1_3}, R_{1_2}, R_{1_1}, and R_{1_0}. When the four light-emitting elements R_{1_3}, R_{1_2}, R_{1_1}, and R_{1_0} emit light in accordance with the drive signal, a spot corresponding to the pixel value (1, 0) is formed on the surface of the photoconductive body 102.

Consider an error that occurs in the image forming apparatus 1 or the exposure apparatus (constituted by the light-emitting chip 300 including the exposure head 106 and the light emission controller 505 as described above) of the image forming apparatus 1. In manufacturing an exposure apparatus or the image forming apparatus 1 including the exposure apparatus, some errors inevitably occur in the layout of components. Even after the manufacture of the image forming apparatus 1, an environmental factor such as a temperature change, the transportation or installation of the image forming apparatus 1, and physical force generated in the image forming apparatus 1 at the time of use can cause a shift in the placement of a component in the apparatus. For example, an error or shift in the placement of a component in the image forming unit 101 leads to an error in the image formation range. An error in the image formation range can typically include one or both of a positional shift component and a magnification error component. A positional shift component indicates the displacement of an image formation position. A relative shift between images of a plurality of color components and the overall shift of an image formation position relative to a sheet are examples of positional shift components. A magnification error component indicates the expansion or reduction of the image formation range. The expansion of the image formation range due to the thermal expansion of the exposure head 106 is an example of a magnification error component.

The next is a case where magnification correction is executed to compensate for a magnification error component. The CPU 501 of the image forming apparatus 1 executes calibration periodically in accordance with an instruction from the user or the fulfillment of some trigger condition in order to determine whether it is necessary to compensate for such an error in the image formation range. More specifically, the CPU 501 controls the image forming unit 101 so as to form a test chart on the transfer belt 111. The test chart in this case can be an image having a known pattern. In forming a test chart as well, multiple exposure is performed by the light-emitting element array of the exposure head 106. In addition, the CPU 501 controls the optical sensor 113 so as to optically read the test chart formed on the transfer belt 111. The optical sensor 113 outputs read image data representing the reading result on the test chart to the CPU 501. The CPU 501 detects an error in the image formation range of the image formed through multiple exposure by comparing the read image data with the known pattern. Accordingly, the CPU 501 according to the present embodiment can function as a detector that detects an error (a positional shift or magnification error) in the image formation range. If an error is detected in the axial direction D1 of the photoconductive body 102 as a result of calibration, the CPU 501 outputs correction data indicating the detected error to the light emission controller 505. This notifies the light emission controller 505 of a magnification error Y detected in the image in the axial direction D1 of the photoconductive body 102. In the following description, the magnification error Y in correction data indicates that there is no magnification error if Y=1, that the expansion of the image formation range is detected if Y>1, and that the reduction of the image formation range is detected if Y<1.

As described above, the light emission controller 505 controls the plurality of light-emitting elements 402 based on the data string of image data for image formation which is used to form an image. If a magnification error is detected in an obtained image along the axial direction D1 of the photoconductive body 102, the light emission controller 505 selects at least one of data included in the data string constituting the image data in accordance with the magnification error Y in a procedure for light emission control of the multiple exposure described above. The light emission controller 505 then performs insertion or thinning-out processing of at least one data of the data string corresponding to at least one row of the plurality of light-emitting elements 402 in accordance with the correction data (the magnification error Y) for correcting the width of the image in the axial direction D1 of the photoconductive body 102. The light emission controller 505 causes the plurality of light-emitting elements 402 to emit light by using the data string having undergone this processing. At this time, the light emission controller 505 has the block division information of the block 701 of the light-emitting chip 300. The block division information may be stored in, for example, the memory in the light emission controller 505. Data insertion or thinning-out processing is performed for data corresponding to the light-emitting elements 402 among the plurality of light-emitting elements 402 excluding the light-emitting elements 402 arranged on the columns at the two ends of each block 701 (along the axial direction D1 of the photoconductive body 102).

Data insertion or thinning-out processing is performed based on the magnification error Y of the correction data. If magnification error Y<1 (the reduction of the image formation range is detected), data insertion is performed. The correction data for magnification error Y<1 can be regarded as correction data indicating that the image formation range is expanded. In the case of magnification error Y>1 (the expansion of the image formation range is detected), data thinning-out is performed. The correction data for magnification error Y<1 can be regarded as correction data indicating that the image formation range is reduced. The light emission controller 505 can determine the number of data subjected to data insertion or thinning-out based on the magnification error Y included in the correction data and the pitch Pₐ of the light-emitting elements 402 in the row direction. Compensation in the case where the reduction of the image formation range is detected (Y<1) and compensation in the case where the expansion of the image formation range is detected (Y>1) will be described separately in detail below.

Compensation in the case where the reduction of the image formation range is detected, that is, compensation to expand the image formation range will be described first. If a magnification error is detected and the magnification error Y is smaller than 1, the light emission controller 505 inserts data at a predetermined position with respect to a data string corresponding to the light-emitting elements 402 on one row which are selected for data insertion among the plurality of light-emitting elements 402. As described above, the predetermined position is the position of data corresponding to the light-emitting element 402 among the plurality of light-emitting elements 402 excluding the light-emitting elements 402 arranged on the columns at the two ends of each block 701 in the row direction. In this case, inserting data at a given position includes shifting data on one side of the row direction with reference to the given position in the direction in which the data string is expanded and copying data (a pixel value) before the shift at the given position to the given position.

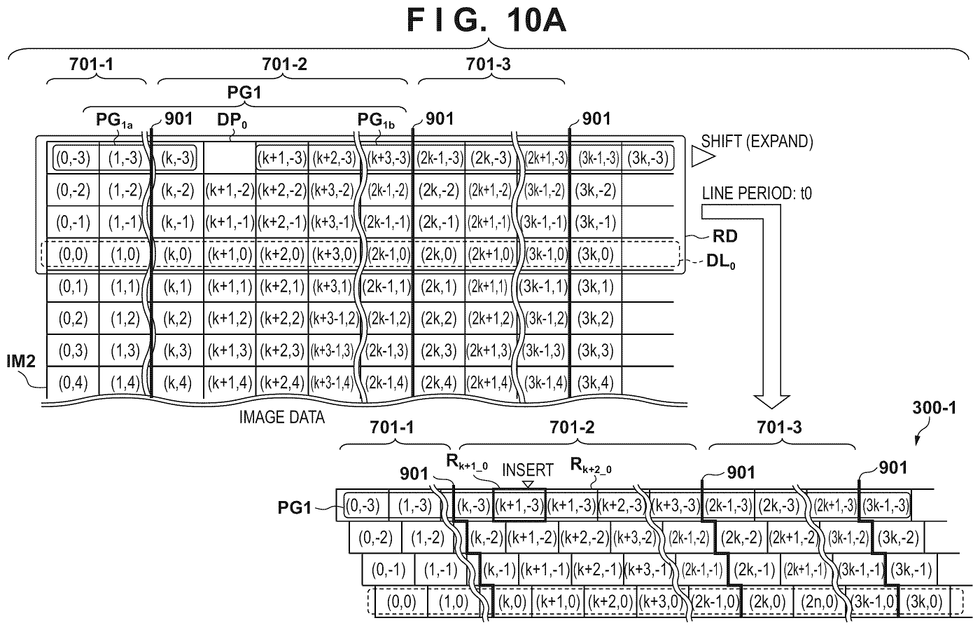

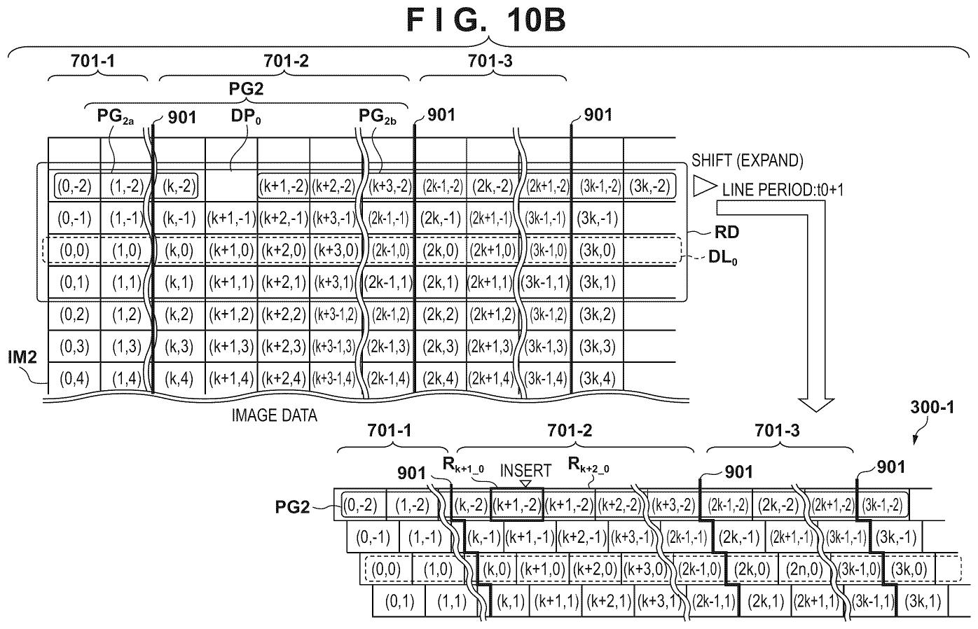

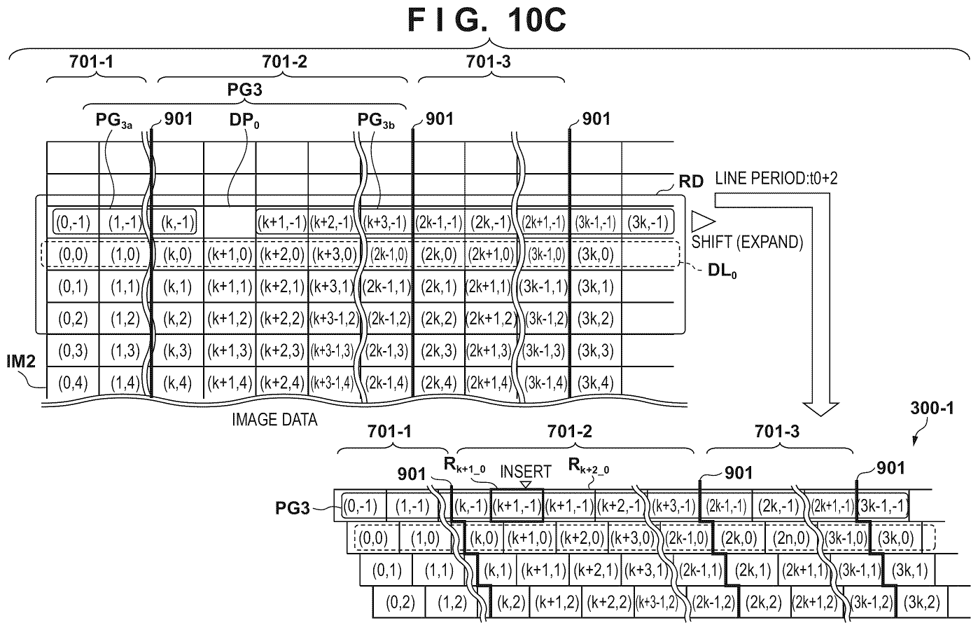

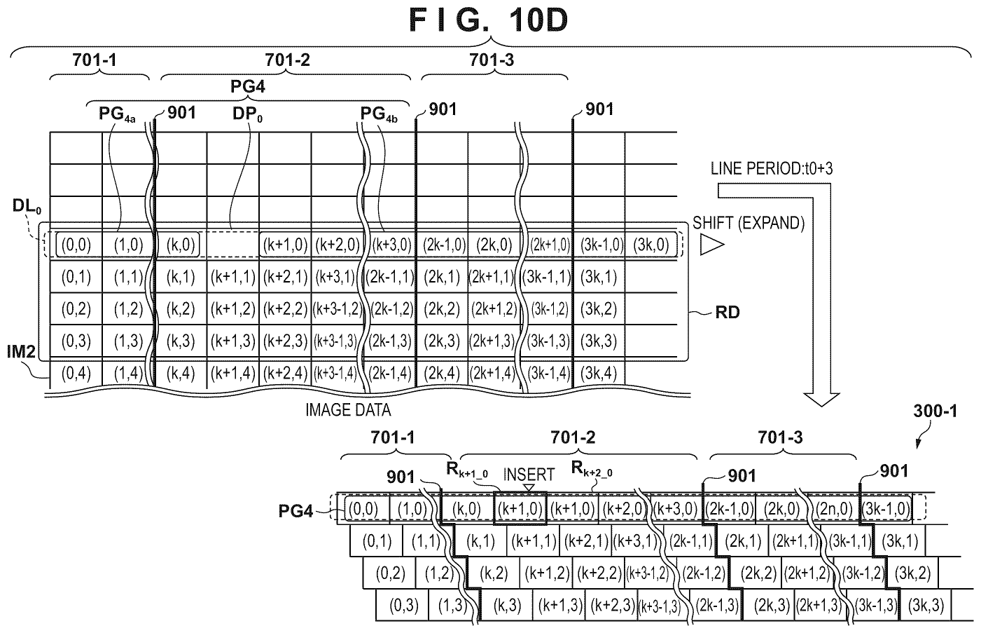

FIGS. 10A to 10D are views for explaining a procedure for light emission control including compensation for a magnification error (data insertion). A case where one piece of data is inserted will be described below. The left side of FIG. 10A shows image data IM2 having dummy pixel values corresponding to three rows added to the beginning. Since the magnification error Y is smaller than 1, the light emission controller 505 selects a position DP₀ where data is inserted in the readout range RD in each line period. In the case of FIG. 10A, in the line period t0, the position DP₀ is selected. The present embodiment exemplifies a case where the position DP₀ is located in the block 701-2. When setting the position DP₀ in the block 701-2, the light emission controller 505 does not select data corresponding to the light-emitting elements 402 in contact with the block boundaries 901 with the adjacent blocks 701-1 and 701-3. In the block 701-2, the light emission controller 505 selects the position DP₀ of data corresponding to the light-emitting element 402 separated from the block boundary 901 to the right or left by at least one pixel value. The position DP₀ belongs to the first row of the readout range RD (the row with index i=−3). The light emission controller 505 inserts data (a pixel value) in a data string PG1 on this row. More specifically, the light emission controller 505 shifts the data (pixel value) of a subset PG1b of the data string PG1 corresponding to the right side of the light-emitting element 402 in the row direction with reference to the position DP₀ to the right one by one and copies a pixel value (k+1, −3) at the position DP₀ before the shift to the position DP₀. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 10A, the data string PG1 corresponds to the light-emitting elements on the first row of the light-emitting element array. As a result of the data (pixel value) insertion, the drive signal based on the pixel value (k+1, −3) at the selected position DP₀ is supplied to a light-emitting element R_{k+1_0} and a light-emitting element R_{k+2_0}, thereby expanding the range of the effective light-emitting elements on the first row by one light-emitting element.

In the present embodiment, data insertion is performed with respect to data corresponding to the light-emitting element 402 among the plurality of light-emitting elements 402 excluding the light-emitting elements 402 arranged on the columns at the two ends of each block 701 in the row direction. However, limitation is not made thereto, and data insertion may be performed with respect to data corresponding to the light-emitting element 402, of the plurality of light-emitting elements 402, which is placed in the middle of each block 701 in the row direction. In this case, the light-emitting element 402 placed in the middle of the block 701 may be the light-emitting element 402 placed in one middle region of the three regions obtained by equally dividing the light-emitting elements 402 in the block 701. Alternatively, the light-emitting element 402 placed in the middle of the block 701 may be the light-emitting element 402 placed in two middle regions of the four regions obtained by equally dividing the light-emitting elements 402 in the block 701. Furthermore, alternatively, the light-emitting element 402 placed in the middle of the block 701 may be the light-emitting element 402 placed in three middle regions of the five regions obtained by equally dividing the light-emitting elements 402 in the block 701.

Referring to FIG. 10B, in a line period t0+1 next to the line period t0, the position DP₀ in the readout range RD is selected again. The selected position DP₀ belongs to the first row of the readout range RD (the row with index i=−2). The light emission controller 505 inserts data (a pixel value) in a data string PG2 on this row. More specifically, the light emission controller 505 shifts the data (pixel value) of a subset PG_{2b} of the data string PG2 on the right side in the row direction with reference to the position DP₀ to the right one by one and copies a pixel value (k+1, −2) at the position DP₀ before the shift to the position DP₀. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 10B, the data string PG2 corresponds to the light-emitting elements on the first row of the light-emitting element array. As a result of the data (pixel value) insertion, the drive signal based on the pixel value (k+1, −2) at the selected position DP₀ is supplied to the light-emitting element R_{k+1_0} and the light-emitting element R_{k+2_0}, thereby expanding the range of the effective light-emitting elements on the first row by one light-emitting element.

Referring to FIG. 10C, in a line period t0+2 next to the line period t0+1, the position DP₀ in the readout range RD is selected for the third time. The selected position DP₀ belongs to the first row of the readout range RD (the row with index i=−1). The light emission controller 505 inserts data (a pixel value) in a data string PG3 on this row. More specifically, the light emission controller 505 shifts the data (pixel value) of a subset PG_{3b} of the data string PG3 on the right side in the row direction with reference to the position DP₀ to the right one by one and copies a pixel value (k+1, −1) at the position DP₀ before the shift to the position DP₀. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 10C, the data string PG3 corresponds to the light-emitting elements on the first row of the light-emitting element array. As a result of the data (pixel value) insertion, the drive signal based on the pixel value (k+1, −1) at the selected position DP₀ is supplied to the light-emitting element R_{k+1_0} and the light-emitting element R_{k+2_0}, thereby expanding the range of the effective light-emitting elements on the first row by one light-emitting element.

Referring to FIG. 10D, in a line period t0+3 next to the line period t0+2, the position DP₀ in the readout range RD is selected for the fourth time. The selected position DP₀ belongs to the first row of the readout range RD (the row with index i=0). The light emission controller 505 inserts data (a pixel value) in a data string PG4 on this row. More specifically, the light emission controller 505 shifts the data (pixel value) of a subset PG_{4b} of the data string PG4 on the right side in the row direction with reference to the position DP₀ to the right one by one and copies a pixel value (k+1, 0) at the position DP₀ before the shift to the position DP₀. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 10D, the data string PG4 corresponds to the light-emitting elements on the first row of the light-emitting element array. As a result of the data (pixel value) insertion, the drive signal based on the pixel value (k+1, 0) at the selected position DP₀ is supplied to the light-emitting element R_{k+1_0} and the light-emitting element R_{k+2_0}, thereby expanding the range of the effective light-emitting elements on the first row by one light-emitting element.

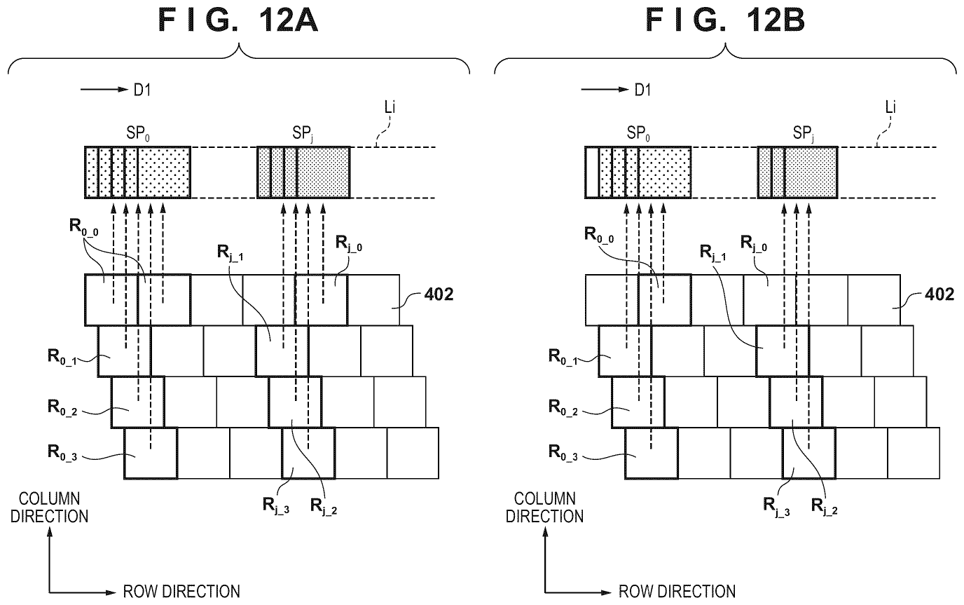

As described above, in the operation shown in FIGS. 10A to 10D, compensation is performed for the detection of the reduction of the image formation range by one pitch. In this operation, for example, the drive signal based on the pixel value (k+1, 0) is supplied to the light-emitting element R_{k+2_0} in addition to four light-emitting elements R_{k+1_m} (m=0 to 3) with index j=k+1. When the five light-emitting elements R_{k+1_m} (m=0 to 3) and R_{k+2_0} emit light in accordance with the drive signal, the expanded spot SP₀ corresponding to the pixel value (k+1, 0) is formed on the surface of the photoconductive body 102, as shown in FIG. 12A. As compared with the case of no compensation for a magnification error (Y=0) described with reference to FIGS. 9A to 9D, the number of light-emitting elements 402 used to form the spot SP corresponding to the same pixel position in an image to be formed changes when a magnification error is compensated for. For example, the number of light-emitting elements for spot formation corresponding to the pixel value (k+1, 0) is four in the case of no compensation for the magnification error Y (Y=0). In contrast, in the operation shown in FIGS. 10A to 10D, this number is five. The same applies to other pixel positions. As described above, the light emission controller 505 changes the number of light-emitting elements 402 for forming at least one of the plurality of spots SP changes (increases in the case of Y<1) from a predetermined number in the case of no compensation for a magnification error in accordance with correction data for correcting the width of the image in the axial direction D1. In this case, the light emission controller 505 shifts the position of the spot SP of another part (corresponding to data on the right side of the position DP₀) in accordance with a change in the number of light-emitting elements for forming at least one spot SP (an increase in the case of Y<1). This expands the image formation range in the axial direction of the photoconductive body 102.

Compensation in a case where the expansion of the image formation range is detected, in other words, compensation to reduce the image formation range will be described next. If a magnification error is detected and the magnification error Y is larger than 1, the light emission controller 505 thins-out data at a predetermined position with respect to a data string corresponding to the light-emitting elements on one row selected from the plurality of light-emitting elements 402 for data thinning-out. As described above, the predetermined position is the position of data corresponding to the light-emitting element 402 among the plurality of light-emitting elements 402 excluding the light-emitting elements 402 arranged on the columns at the two ends of each block 701 in the row direction. In this case, thinning-out data at a given position includes erasing data (a pixel value) at the given position before the thinning-out and shifting data on one side in the axial direction in a direction to reduce the data string with reference to the given position.

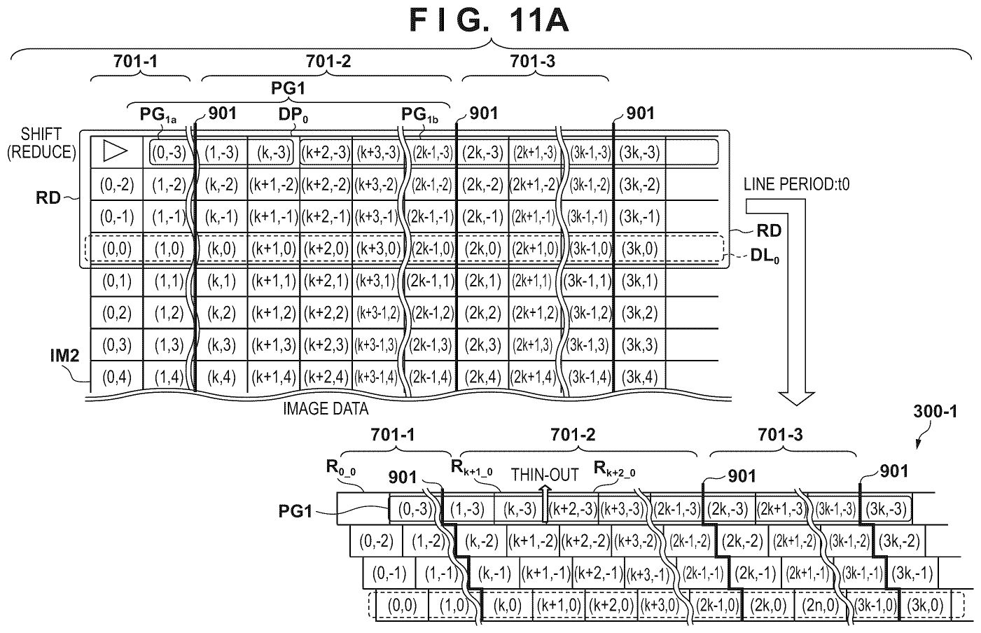

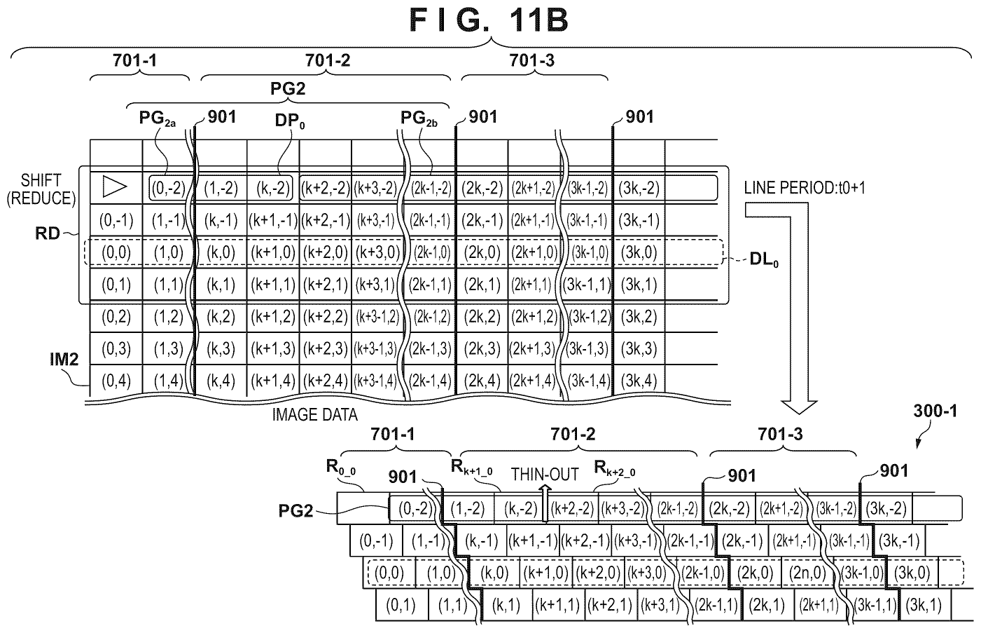

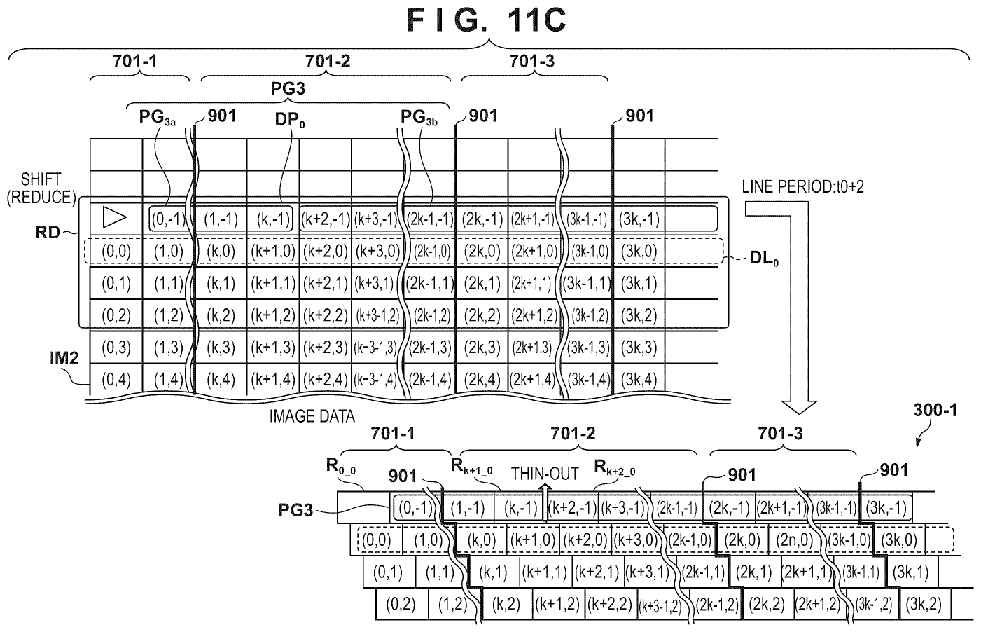

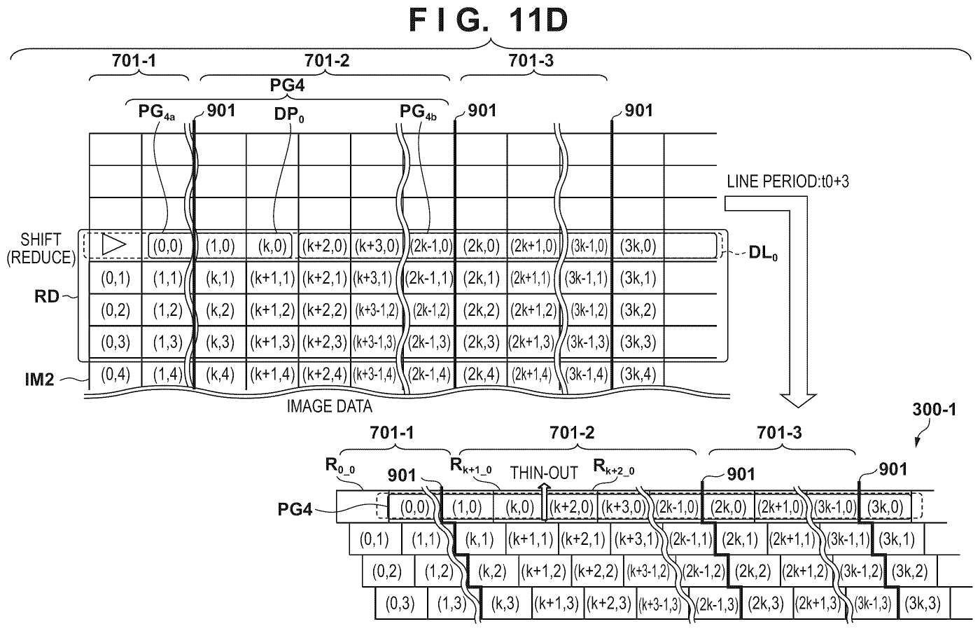

FIGS. 11A to 11D are views for explaining a procedure for light emission control including compensation for a magnification error (data thinning-out). A case where one data is thinned-out will be described here. The left side of FIG. 11A shows image data IM2 having dummy pixel values corresponding to three rows added to the beginning. Since the magnification error Y is larger than 1, the light emission controller 505 selects a position DP₀ where data is thinned-out in the readout range RD in each line period. In the case of FIG. 11A, in the line period to, the position DP₀ is selected. The present embodiment exemplifies a case where the position DP₀ is located in the block 701-2. When setting the position DP₀ in the block 701-2, the light emission controller 505 does not select data corresponding to the light-emitting elements 402 in contact with the block boundaries 901 with the adjacent blocks 701-1 and 701-3. In the block 701-2, the light emission controller 505 selects the position DP₀ of data corresponding to the light-emitting element 402 separated from the block boundary 901 to the right or left by at least one pixel value. The position DP₀ belongs to the first row of the readout range RD (the row with index i=−3). The light emission controller 505 thins-out the data (pixel value) at the position DP₀ from the data string PG1 on this row. More specifically, the light emission controller 505 erases the pixel value (k+1, −3) at the position DP₀ before the shift and shifts the data (pixel value) of the subset PG₁ₐ of the data string PG1 on the left side in the row direction to the right one by one with reference to the position DP₀. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 11A, the data string PG1 corresponds to the light-emitting elements on the first row of the light-emitting element array. As a result of the data (pixel value) thinning-out, the drive signal based on the pixel value (k+1, −3) at the selected position DP₀ is not supplied to any light-emitting elements, thereby reducing the range of the effective light-emitting elements on the first row by one light-emitting element.

In the present embodiment, data thinning-out is performed with respect to data corresponding to the light-emitting element 402 among the plurality of light-emitting elements 402 excluding the light-emitting elements 402 arranged on the columns at the two ends of each block 701 in the row direction. However, limitation is not made thereto, and data thinning-out may be performed with respect to data corresponding to the light-emitting element 402, of the plurality of light-emitting elements 402, which is placed in the middle of each block 701 in the row direction. In this case, the light-emitting element 402 placed in the middle of the block 701 may be the light-emitting element 402 placed in one middle region of the three regions obtained by equally dividing the light-emitting elements 402 in the block 701. Alternatively, the light-emitting element 402 placed in the middle of the block 701 may be the light-emitting element 402 placed in two middle regions of the four regions obtained by equally dividing the light-emitting elements 402 in the block 701. Furthermore, alternatively, the light-emitting element 402 placed in the middle of the block 701 may be the light-emitting element 402 placed in three middle regions of the five regions obtained by equally dividing the light-emitting elements 402 in the block 701.

Referring to FIG. 11B, in the line period t0+1 next to the line period t0, the position DP₀ in the readout range RD is selected again. The selected position DP₀ belongs to the first row of the readout range RD (the row with index i=−2). The light emission controller 505 thins-out the data (pixel value) at the position DP₀ from the data string PG2 on this row. More specifically, the light emission controller 505 erases the pixel value (k+1, −2) at the position DP₀ before shift and shifts the data (pixel value) of a subset PG₂ₐ of the data string PG2 on the left side in the row direction with reference to the position DP₀ to the right one by one. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 11B, the data string PG2 corresponds to the light-emitting elements on the first row of the light-emitting element array. As a result of the data (pixel value) thinning-out, the drive signal based on the pixel value (k+1, −2) at the selected position DP₀ is not supplied to any light-emitting elements, thereby reducing the range of the effective light-emitting elements on the first row by one light-emitting element.

Referring to FIG. 11C, in the line period t0+2 next to the line period t0+1, the position DP₀ in the readout range RD is selected for the third time. The selected position DP₀ belongs to the first row of the readout range RD (the row with index i=−1). The light emission controller 505 thins-out the data (a pixel value) at the position DP₀ from the data string PG3 on this row. More specifically, the light emission controller 505 erases the pixel value (k+1, −1) at the position DP₀ before shift and shifts the data (pixel value) of a subset PG₃ₐ of the data string PG3 on the left side in the row direction with reference to the position DP₀ to the right one by one. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 11C, the data string PG3 corresponds to the light-emitting elements on the first row of the light-emitting element array. As a result of the data (pixel value) thinning-out, the drive signal based on the pixel value (k+1, −1) at the selected position DP₀ is not supplied to any light-emitting elements, thereby reducing the range of the effective light-emitting elements on the first row by one light-emitting element.

Referring to FIG. 11D, in the line period t0+3 next to the line period t0+2, the position DP₀ in the readout range RD is selected for the fourth time. The selected position DP₀ belongs to the first row of the readout range RD (the row with index i=0). The light emission controller 505 thins-out data (a pixel value) at the position DP₀ from the data string PG4 on this row. More specifically, the light emission controller 505 erases the pixel value (k+1, 0) at the position DP₀ before shift and shifts the data (pixel value) of a subset PG₄ₐ of the data string PG4 on the left side in the row direction with reference to the position DP₀ to the right one by one. The light emission controller 505 then reads out the data of pixel values in increments of 3,488 pixel values from the image data IM2 and outputs the read data to the light-emitting chip 300 via the signal line DATAn. In the light-emitting chip 300-1 shown on the right side of FIG. 11D, the data string PG4 corresponds to the light-emitting elements on the first row of the light-emitting element array. As a result of the data (pixel value) thinning-out, the drive signal based on the pixel value (k+1, 0) at the selected position DP₀ is not supplied to any light-emitting elements, thereby reducing the range of the effective light-emitting elements on the first row by one light-emitting element.

As described above, in the operation shown in FIGS. 11A to 11D, compensation is performed for the detection of the expansion of the image formation range by one pitch. In this operation, for example, the drive signal based on the pixel value (k+1, 0) is supplied to the three light-emitting elements R_{k+1_m} (m=1 to 3) of the four light-emitting elements R_{k+1_m} (m=0 to 3) with index j=k+1 excluding the light-emitting element R_{k+1_0}. When the three light-emitting elements R_{k+1_m} (m=1 to 3) emit light in accordance with the drive signal, a reduced spot SPⱼ corresponding to the pixel value (k+1, 0) is formed on the surface of the photoconductive body 102, as shown in FIG. 12B. As compared with the case of no compensation for a magnification error (Y=0) described with reference to FIGS. 9A to 9D, the number of light-emitting elements 402 used to form the spot SP corresponding to the same pixel position in an image to be formed changes when a magnification error is compensated for. For example, the number of light-emitting elements for spot formation corresponding to the pixel value (0, 3) is four in the case of no compensation for the magnification error Y (Y=0). In contrast, in the operation shown in FIGS. 11A to 11D, this number is three. The same applies to other pixel positions. As described above, the light emission controller 505 changes the number of light-emitting elements 402 for forming at least one of the plurality of spots SP changes (decreases in the case of Y>1) from a predetermined number in the case of no compensation for a magnification error in accordance with correction data for correcting the width of the image in the axial direction D1. In this case, the light emission controller 505 shifts the position of the spot SP of another part (corresponding to data on the left side of the position DP₀) in accordance with a change in the number of light-emitting elements for forming at least one spot SP (a decrease in the case of Y>1). This reduces the image formation range in the axial direction of the photoconductive body 102.

The light emission controller 505 determines a predetermined position where data (a pixel value) is to be inserted or thinned-out based on the correction data supplied from the CPU 501. In other words, the light emission controller 505 can control the width of an image to be formed along the axial direction D1 of the photoconductive body 102 by inserting or thinning-out data (a pixel value) based on the correction data. That is, the above correction data is data for correcting the image width along the axial direction of the photoconductive body 102.

The plurality of light-emitting elements 402 on the light-emitting chip 300 are divided into the plurality of blocks 701 as described above, and the respective blocks are driven by different drive circuits. For example, the light-emitting elements O11 to O1k arranged in the block 701-1 are driven by a drive circuit including the transistor M1a of the current control circuit 613, and the first transistors M11 to M1k and the second transistors M111 to M11k of the drive transistor 614. The light-emitting elements Oi1 to Oik arranged in the block 701-i are driven by a drive circuit including the transistor Mia of the current control circuit 613, and the first transistors Mi1 to Mik and the second transistors Mi11 to Milk of the drive transistor 614. Relative variation between the drive circuits of the blocks 701 can cause light amount variation between the light-emitting elements 402 belonging to the blocks 701-1 and 701-2. For example, this light amount variation originates from the manufacture variation of transistors included in a drive circuit and is visually recognized as unevenness (light and dark) of an image formed by the image forming apparatus 1. For this reason, design is made to suppress variation between the blocks 701 so as to make the light amount variation unrecognizable as image unevenness.

In contrast, in compensating for a magnification error in the manner described above, the number of light-emitting elements 402 that form the spot SP corresponding to a pixel of an image to be formed is adjusted in accordance with the magnification to be corrected. If, for example, correction is not performed, the spot SP is formed by the four light-emitting elements 402. If correction is made to expand the image formation range, some spots SP are formed by using the five light-emitting elements 402. If correction is made to reduce the image formation range, some spots SP are formed by using the three light-emitting elements 402.

If compensation for a magnification error is applied to the light-emitting chip 300 in which the light-emitting elements 402 are driven by different drive circuits for each block 701, light amount variation due to correction can increase at the block boundary 901 between the blocks 701. This can affect the print quality. For example, let L1 be the light amount of one light-emitting element 402 driven in the block 701-1, and L1+ΔL be the light amount of one light-emitting element 402 driven in the block 701-2. The light amount in the formation of the spot SP in the case of no correction is 4×L1 in the block 701-1 and is 4×L1+4×ΔL in the block 701-2. On the other hand, the light amount in the formation of the spot SP in the case of correction to expand the image formation range is 5×L1 in the block 701-1 and is 5×L1+5×ΔL in the block 701-2. The light amount in the formation of the spot SP in the case of correction to reduce the image formation range is 3×L1 in the block 701-1 and is 3×L1+3×ΔL in the block 701-2. In a case where the spot SP formed by using the four light-emitting elements 402 is adjacent to the spot SP formed by using the five light-emitting elements 402 in the block 701-1, the light amount difference between the adjacent spots SP is L1. In a case where the spot SP formed by using the four light-emitting elements 402 in the block 701-1 is adjacent to the spot SP formed by using the five light-emitting elements 402 in the block 701-2, the light amount difference between the adjacent spots SP is L1+5×ΔL. That is, in performing data insertion or thinning-out for compensation for a magnification error at the boundary between the blocks 701, two elements, namely, variation between the blocks 701 and the number of light-emitting elements 402 for forming the spot SP, may lead to an increase in the light amount difference between the adjacent spots SP. This may affect the print quality.

In the present embodiment, the light emission controller 505 performs insertion or thinning-out of at least one data with respect to a data string corresponding to at least one row of the plurality of light-emitting elements 402 based on the correction data supplied from the CPU 501. In this case, data insertion or thinning-out is performed for data corresponding to the light-emitting element 402 among the plurality of light-emitting elements 402 excluding the light-emitting elements 402 on the columns arranged at the two ends of each block 701 in the row direction. With this operation, the spot SP where the number of light-emitting elements 402 used to form an electrostatic latent image changes from that in the case of no correction (compensation) is formed by using the light-emitting element 402 among the plurality of light-emitting elements 402 excluding the light-emitting elements 402 on the columns arranged at the two ends of each block 701 in the row direction. This suppresses the influence of light emission amount unevenness due to variation in light emission amount caused between the blocks 701, thereby suppressing image unevenness. The block 701 in one light-emitting chip 300 has been described above. However, limitation is not made thereto. As shown in FIG. 3, the plurality of light-emitting chips 300 are arranged in the light-emitting element array 201 along the axial direction D1 of the photoconductive body 102. Accordingly, data insertion or thinning-out may be performed for data corresponding to the light-emitting element 402 among the plurality of light-emitting elements 402 excluding the light-emitting elements 402 arranged on the columns at the two ends of the light-emitting chip 300. With this operation, the spot SP where the number of light-emitting elements 402 used to form an electrostatic latent image changes from that in the case of no correction (compensation) is formed by using the light-emitting element 402 among the plurality of light-emitting elements 402 excluding the light-emitting elements 402 arranged on the columns at the two ends of the light-emitting chip 300 in the row direction. The light-emitting elements 402 arranged on the two ends of the light-emitting chip 300 in the row direction can be the light-emitting elements 402 arranged on one of the ends in the row direction of the block 701.

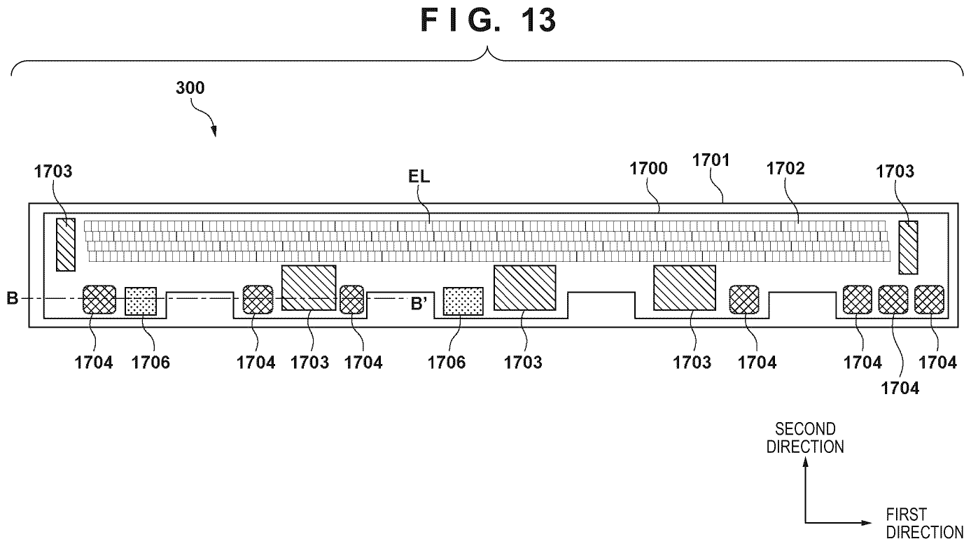

FIG. 13 is a schematic view showing one form of the light-emitting chip 300 according to the present embodiment. The light-emitting chip 300 according to the present embodiment can be used as, for example, the light source of an image forming apparatus. The light-emitting chip 300 according to the present embodiment may have a rectangular shape having long sides parallel to the first direction and short sides parallel to a direction intersecting the first direction. For example, the first direction may be a direction along the rotational axis direction (the axial direction D1) of the photoconductive body 102 of the image forming apparatus 1.

A substrate 1701 has a polygonal shape. An example of the substrate 1701 having a rectangular shape will be described here. In this specification, the long side direction of the rectangular substrate 1701 is called the first direction, and the short side direction orthogonal to the long side direction is called the second direction. The polygonal shape in the specification includes a shape having round corners. A moisture-resistant ring 1700 is placed on the substrate 1701. The moisture-resistant ring 1700 serves to suppress and prevent moisture from entering the light-emitting chip 300. The moisture-resistant ring 1700 may be a guard ring formed from a wiring layer.

The moisture-resistant ring 1700 is internally provided with a light emission region 1702, contact regions 1703, pads 1704, and circuits 1706. The circuits 1706 are some circuits each for driving the light-emitting chip. Specific examples of the circuits include an input protection circuit, an input circuit to which each drive data is input, and a logic circuit for processing data. However, limitation is not made thereto. Light-emitting elements EL are arrayed in the row and column directions in the light emission region 1702. The contact regions 1703 are regions where wiring electrically connected to the common electrodes of the light-emitting elements EL is arranged. The pads 1704 electrically connect the contact regions 1703 and the circuits 1706 to external elements.

The outer peripheral shape of the moisture-resistant ring 1700 may have a plurality of concave portions. These portions can be used as, for example, abutment regions on which ribs as parts of a mask for vapor deposition in a film forming process are made to abut.

Each of the plurality of light-emitting elements EL arrayed in a matrix pattern in the light emission region 1702 is constituted by a light-emitting layer and first and second electrodes sandwiching the light-emitting layer. In the present embodiment, the first electrode can be an independent electrode provided for each light-emitting element EL, and the second electrode can be a common electrode commonly provided for the respective light-emitting elements EL.

If, for example, the light-emitting elements EL are arranged on four rows in the light emission region 1702, the position of the first light-emitting element EL on the first row and the position of the first light-emitting element EL on the second row may be shifted from each other by ¼ of the X-direction size of the light-emitting element EL in the first direction, as exemplified in FIG. 13. In the case of n rows (where n is an integer of 2 or more), the position of the first light-emitting element EL on the first row and the position of the first light-emitting element EL on the second row may be shifted from each other by 1/n of the X-direction size of the light-emitting element EL in the X direction. Such arrangement is advantageous in improving the resolution.

The contact regions 1703 are adjacent regions of the light emission region 1702 of the substrate 1701 and arranged inside the moisture-resistant ring 1700. At least one of the contact region 1703, the pad 1704, and the circuit 1706 may be placed between the light emission region 1702 and one of the long side end portions of the substrate 1701 together with the concave portion of the moisture-resistant ring 1700 and located in series with the long side direction (the first direction).

Providing the contact regions 1703, the pads 1704, and the circuits 1706 at positions in the same short side direction in this manner can reduce the length of the light-emitting chip 300 in the short side direction (second direction) and downsize the light-emitting chip 300.

The light-emitting chip 300 according to the present embodiment includes the plurality of contact regions 1703 between the common electrodes and the power supply wiring of the light-emitting elements EL along the long side end of the light-emitting chip. If, for example, the common electrode is made of a transparent electrode material having a relatively high electric resistance, the voltage drop amount sometimes increases in the long side direction. The voltages applied to the respective OLEDs differ depending on the distances from the contact regions to which potentials are supplied. This causes differences in actual light emission brightness among the OLEDs to which voltages for light emission of the same brightness are applied, thus sometimes causing shading or the like. As in the present embodiment, having the plurality of contact regions 1703 in the long side direction can suppress voltage drops at the common electrodes in the long side direction, thereby suppressing the occurrence of shading or the like.

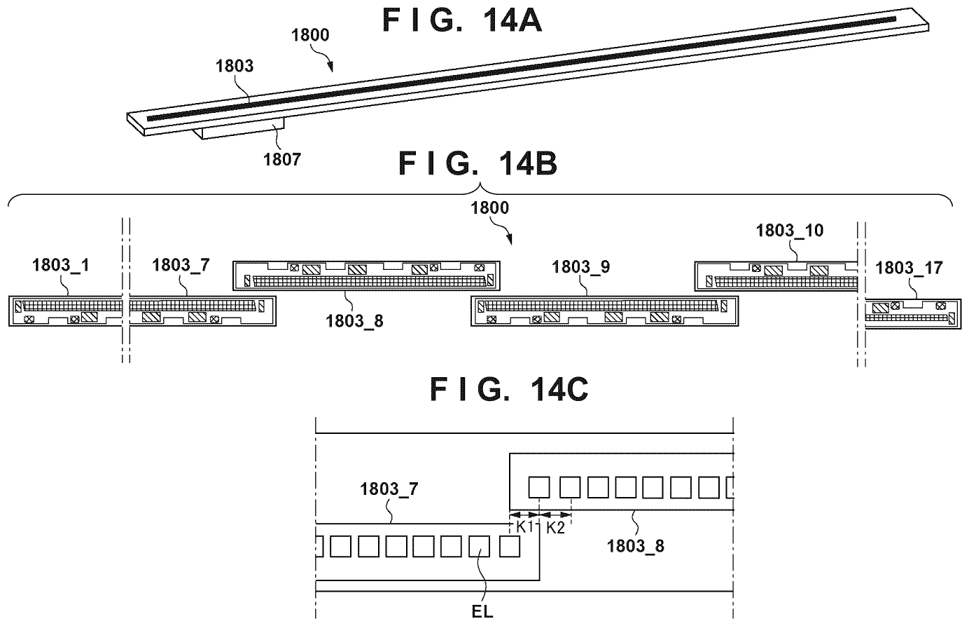

The present embodiment describes, with reference to FIGS. 14A to 14C, an example of using the light-emitting chip 300 for a head substrate 1800 of an exposure head as a light-emitting module of an image forming apparatus. FIG. 14A is a schematic perspective view of the head substrate 1800. FIG. 14B shows an array of the plurality of light-emitting elements EL provided on the head substrate 1800. FIG. 14C is an enlarged view of part of FIG. 14B.

LED chips 1803 are mounted on the head substrate 1800. As the LED chip 1803, for example, the light-emitting chip 300 described above can be used.

As shown in FIG. 14A, the LED chips 1803 are provided on one surface of the head substrate 1800, and a long flexible flat cable (FFC) connector 1807 is provided on the other surface. One surface of the head substrate 1800 in this case is the surface (the upper surface or obverse surface) on which the LED chips 1803 are provided. The other surface of the substrate is the surface (the lower surface or reverse surface) opposite to the side where the LED chips 1803 are provided.

The FFC connector 1807 is attached to the other surface (the lower surface or reverse surface) of the head substrate 1800 such that the longitudinal direction of the FFC connector 1807 extends along the longitudinal direction of the head substrate 1800. The long FFC connector 1807 is provided to receive a control signal (drive signal) from a control circuit unit of the main body of the image forming apparatus. The control signal is transferred to each LED chip 1803. The LED chip 1803 is driven (for light emission or turn-off operation) in accordance with the control signal input to the head substrate 1800.

The LED chips 1803 mounted on the head substrate 1800 will be described. As shown in FIGS. 14B and 14C, the plurality of light-emitting elements EL are arranged on one surface of the head substrate 1800. For example, a plurality (17) of LED chips 1803-1 to 1803-17 are arrayed. FIG. 14B exemplarily shows the LED chips 1803_1, 1803_7, 1803_8, 1803_9, 1803_10, and 1803_17. In each of the LED chips 1803_1 to 1803_17, the plurality of light-emitting elements EL are arranged in the longitudinal direction, and for example, 516 light-emitting elements EL are arrayed.

An inter-center distance k2 of the adjacent light-emitting elements EL in the longitudinal direction of the LED chip 1803 corresponds to the resolution of the image forming apparatus. If, for example, the resolution of the image forming apparatus according to the present embodiment is 1,200 dpi, the light-emitting elements EL are arrayed such that the inter-center distance k2 between the adjacent light-emitting elements EL in the longitudinal direction of the LED chips 1803_1 to 1803_17 is 21.16 μm. Accordingly, the exposure range of the exposure head according to the present embodiment becomes about 314 mm.

The photoconductive layer of the photoconductive drum is formed to have a width of 314 mm or more. Since the length of a long side of an A4 size recording sheet and the length of a short side of an A3 size recording sheet are 297 mm, the exposure head according to the present embodiment has an exposure range that allows the formation of images on both an A4 size recording sheet and an A3 size recording sheet. FIG. 14C shows an example in which the plurality of light-emitting elements EL are arrayed in the longitudinal direction. However, the light-emitting elements EL may be arrayed in the transverse direction in addition to the longitudinal direction.

The LED chips 1803_1 to 1803_17 are arrayed in the axial direction of the photoconductive drum. More specifically, the LED chips 1803_1 to 1803_17 are arranged in two lines along the axial direction of the photoconductive drum. That is, as shown in FIG. 14B, the odd-numbered LED chips 1803_1, 1803_3, . . . 1803_17, counted from the left, are mounted in one line in the longitudinal direction of the head substrate 1800. The even-numbered LED chips 1803_2, 1803_4, . . . 1803_16, counted from the left, are mounted in one line in the longitudinal direction of the head substrate 1800. The LED chips 1803 are arranged in this manner. As exemplified in FIG. 14C, this makes it possible to equalize an inter-center distance k1 between the light-emitting elements EL with an inter-center distance k2 between the light-emitting elements EL in the longitudinal direction of the LED chip 1803. The inter-center distance k1 between the light-emitting elements EL indicates the inter-center distance between the light-emitting element EL on one end of the LED chip 18037 and the light-emitting element EL on the other end of the LED chip 1803_8. The inter-center distance k2 between the light-emitting elements EL indicates the inter-center distance k2 between the adjacent light-emitting elements EL in the LED chip 1803_8.

That is, it is possible to equalize the inter-center distance k1 between the adjacent light-emitting elements EL arranged on one end of the LED chip 1803 and the other end of the other LED chip 1803 with the inter-center distance k2 between the adjacent light-emitting elements EL on one LED chip 1803.

Note that the light-emitting element EL according to the present embodiment is an organic light-emitting element and a current-driven light-emitting element. For example, organic light-emitting elements are arranged on a line on a TFT substrate along the main scanning direction (the axial direction D1 of the photoconductive body 102) and are electrically connected in parallel to each other with a power supply wiring provided along the main scanning direction.

If light-emitting devices are used for an exposure head, to perform linear exposure, the light emission region 1702 is shaped such that the ratio between the length in the longitudinal direction (first direction) and the length in the transverse direction (second direction) becomes large as compared with a case where light-emitting devices are used for a display apparatus or the like. The substrate of each LED chip is also shaped such that the ratio between the length in the longitudinal direction (first direction) and the length in the transverse direction (second direction) becomes large.

More specifically, for example, the length of a long side of the LED chip 1803 (or the light emission region 1702) is five or more times or may be 10 or more times the length of a short side of the LED chip 1803 (or the light emission region 1702). For example, the length of a long side of the LED chip 1803 (or the light emission region 1702) can be 20 or more times the length of a short side of the LED chip 1803 (or the light emission region 1702).

The length of a long side of the LED chip 1803 is determined by the length of the photoconductive drum in the axial direction, the number of LED chips arranged in the axial direction, and the manner of arranging the LED chips 1803. The length of a short side of the LED chip 1803 is determined by whether the light-emitting elements EL are arranged in the light emission region 1702 in a direction perpendicular to the axis of the photoconductive drum and the placements of the pads 1704 and the contact regions 1703.

In addition, the organic layer can be configured to have a light-emitting layer that emits red light in consideration of the wavelength dependence of the photosensitivity of the photoconductive drum. The LED chip 1803 may have a color filter. Having a color filter makes it possible to absorb stray light from unintentional directions without reducing the regular amount of light incident on the photoconductive drum, thereby improving the print quality.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priority to Japanese Patent Application No. 2024-093863, which was filed on Jun. 10, 2024, and which is hereby incorporated by reference herein in its entirety.

What is claimed is:

1. An exposure apparatus comprising:
a light-emitting chip including a plurality of light-emitting elements that constitute a plurality of rows and a plurality of columns and are arranged such that a row direction extends along an axial direction of a photoconductive body; and
a light emission controller configured to control the light-emitting chip,
wherein a light emission region in which the plurality of light-emitting elements are arranged is divided into a plurality of blocks arranged along the row direction, and each light-emitting element is driven by a drive circuit provided in correspondence with a block to which the light-emitting element belongs,
the light emission controller is configured to control the plurality of light-emitting elements so as to form, on the photoconductive body, an electrostatic latent image that is for forming an image and is constituted by a plurality of spots, during rotation of the photoconductive body, and each of the plurality of spots is formed by a predetermined number of light-emitting elements among the plurality of light-emitting elements,
the light emission controller is configured to change the number of light-emitting elements that form at least one spot among the plurality of spots from the predetermined number in accordance with correction data for correcting a width of the image in the axial direction, and shifts, in accordance with a change in the number of light-emitting elements that form the at least one spot, positions of some of other spots, and
the at least one spot is formed by using a light-emitting element among the plurality of light-emitting elements excluding light-emitting elements provided on columns at two ends of each block in the row direction.

2. The apparatus according to claim 1, wherein the at least one spot is formed by using a light-emitting element, of the plurality of light-emitting elements, which is provided in middle of each block in the row direction.

3. The apparatus according to claim 1, wherein the light emission controller is configured to increase the number of light-emitting elements for forming the at least one spot from the predetermined number if the correction data indicates expansion of an image formation range, and is configured to decrease the number of light-emitting elements for forming the at least one spot from the predetermined number if the correction data indicates reduction of the image formation range.

4. The apparatus according to claim 1, wherein a plurality of light-emitting chips including the light-emitting chip are arranged along the axial direction in the exposure apparatus, and
the at least one spot is not formed by light-emitting elements arranged on columns at two ends of each light-emitting chip in the row direction.

5. The apparatus according to claim 4, wherein the plurality of light-emitting chips are arranged in a staggered pattern.

6. The apparatus according to claim 1, wherein light-emitting elements, of the plurality of light-emitting elements, which are arranged on each column are arranged such that at least one light-emitting element is partially shifted in the row direction.

7. The apparatus according to claim 1, wherein light-emitting elements, of the plurality of light-emitting elements, which are arranged on each column are arranged so as to be partially shifted stepwise at a predetermined pitch in the row direction.

8. The apparatus according to claim 1, wherein the light emission controller is configured to control the plurality of light-emitting elements based on an image formation data string for forming an image, and
the light emission controller is configured to insert or thin-out data corresponding to the at least one spot with respect to the data string corresponding to at least one row of the plurality of light-emitting elements in accordance with the correction data.

9. An exposure apparatus comprising:
a light-emitting chip including a plurality of light-emitting elements that constitute a plurality of rows and a plurality of columns and are arranged such that a row direction extends along an axial direction of a photoconductive body; and
a light emission controller configured to control the light-emitting chip,
wherein a light emission region in which the plurality of light-emitting elements are arranged is divided into a plurality of blocks arranged along the row direction, and each light-emitting element is driven by a drive circuit provided in correspondence with a block to which the light-emitting element belongs,
the light emission controller is configured to control the plurality of light-emitting elements based on an image formation data string for forming an image,
the light emission controller is configured to perform insertion or thinning-out processing of at least one data of the data string corresponding to at least one row of the plurality of light-emitting elements in accordance with correction data for correcting a width of the image in the axial direction, and
the processing is performed for data corresponding to a light-emitting element among the plurality of light-emitting elements excluding light-emitting elements arranged on columns at two ends of each block in the row direction.

10. An image forming apparatus comprising:
the exposure apparatus according to claim 1; and
the photoconductive body.
